(19) United States
(12) Patent Application Publication
(10) Pub. No.: US 2018/0057262 A1
(43) Pub. Date: Mar. 1, 2018

(54) INFORMATION PROCESSING APPARATUS, ORDERING SUPPORT METHOD, AND SUPPORT METHOD

(71) Applicant: NEC Corporation, Tokyo (JP)

(72) Inventors: Norihisa MITSUYU, Tokyo (JP); Shinichi KUBORI, Tokyo (JP)

(73) Assignee: NEC Corporation, Tokyo (JP)

(21) Appl. No.: 15/558,585

(22) PCT Filed: Mar. 10, 2016
(86) PCT No.: PCT/JP2016/057629

§ 371 Date: Sep. 15, 2017

(30) Foreign Application Priority Data
Mar. 18, 2015 (JP) 2015-055253

(51) Int. Cl. B65G 1/137; G06Q 10/08

(52) U.S. Cl. CPC B65G 1/137; G06Q 10/087

(57) ABSTRACT

An information processing apparatus includes an acquisition module that acquires information related to an ordering candidate product based on a relationship between a current time and an ordering timing stored in a first storage module that stores ordering timing information of a product, an extraction module that extracts the ordering candidate product or person-in-charge information who manages a location in which the ordering candidate product is located from a second storage module that stores the product or the person-in-charge information who manages a location in which the product is located, and a transmission processing module that transmits the acquired information related to the ordering candidate product to a mobile apparatus of a person in charge who is indicated by the extracted person-in-charge information.

### TECHNICAL FIELD

The present invention relates to a technology for supporting a customer or a salesperson in a store.

### BACKGROUND ART

There are many large stores having a wide selling section area. In such a store, there are some cases where it is difficult for a salesperson or a customer to know a location in which a desired product is displayed. Such a circumstance may also occur in a store such as a bookstore or a rental shop that handles many products, in addition to the large store. In a retail store such as a convenience store, since the number of salespersons is small, the salesperson needs to perform a plurality of operations such as a cashier operation, a shipment operation, a cleaning operation, an inventory confirm operation, and an ordering operation.

Patent Document 1 suggests a method of supporting a cashier operation, an inventory confirm operation, or an inventory registration operation by using a wearable terminal apparatus including a head-mounted display. Specifically, the wearable terminal apparatus transitions to any one of a checkout mode, a display shelf mode, and an inventory registration mode by recognizing a barcode within the eye-sight of the wearer, and performs a checkout process, displays inventory information, or registers the inventory information. Patent Document 2 suggests various methods using a wearable device. For example, in this method, the wearable device sends lighting ID information received from lighting equipment through visible light communication to a smartphone, and the smartphone receives point information or coupon information of a store from a server based on the lighting ID information and user information. With such a configuration, a user can be guided to a display location within the store (see paragraph [1998]). Further, a method of supporting a purchase behavior of the user by using information acquired from the server by the smartphone is suggested. In this method, the wearable device displays an arrow or the like, and thus, the user is guided to a specific location. If the user is guided to the front of a product shelf, a screen is changed into a screen for inquiring about whether or not to buy the product (see paragraph [2004]).

### RELATED DOCUMENT

### Patent Document

[Patent Document 1] Japanese Patent Application Publication No. 2011-14082

[Patent Document 2] Japanese Patent No. 5590431

### SUMMARY OF THE INVENTION

### Technical Problem

However, in the suggested methods, there is a room for further supporting the salesperson or the customer. For example, in the suggested methods, a method of supporting an ordering operation of the salesperson is not suggested. In the suggested methods, a method of guiding the customer to the front of a display shelf that displays a desired product is suggested, but the customer needs to find the product on the guided display shelf in a case where the customer wants to get the desired product.

The present invention has been made in view of the aforementioned circumstances, and provides a technology for supporting a salesperson or a customer in a store.

### Solution to Problem

In order to solve the aforementioned problems, the aspects of the present invention adopt the following configurations, respectively.

A first aspect relates to an information processing apparatus. The information processing apparatus according to the first aspect includes: an acquisition module acquiring information related to an ordering candidate product based on a relationship between a current time and an ordering timing stored in a first storage module that stores ordering timing information of a product; an extraction module extracting, from a second storage module, person-in-charge information of the ordering candidate product or a location in which the ordering candidate product is located, the second storage module storing the person-in-charge information of a product or a location in which the product is located; and a transmission processing module transmitting the acquired information related to the ordering candidate product to a mobile apparatus of a person in charge who is indicated by the extracted person-in-charge information.

A second aspect relates to an ordering support method performed a computer capable of communicating with a mobile apparatus. The ordering support method according to the second aspect includes: acquiring information related to an ordering candidate product based on a relationship between a current time and an ordering timing stored in a first storage module that stores ordering timing information of a product; extracting, from a second storage module, person-in-charge information of the ordering candidate product or a location in which the ordering candidate product is located, the second storage module storing the person-in-charge information of a product or a location in which the product is located; and transmitting the acquired information related to the ordering candidate product to a mobile apparatus of a person in charge who is indicated by the extracted person-in-charge information.

A third aspect relates to an information processing apparatus. The information processing apparatus according to the third aspect includes: an acquisition module acquiring an image; a confirmation module confirming that an entire display shelf or a part of the display shelf on which a target product is located is included in the acquired image; and a display processing module outputting to a display module display data that emphasizes a location in which the target product is located on the display shelf on which the target product is located, after the confirmation is performed.

A fourth aspect relates to a support method performed by a computer. The support method according to the fourth aspect includes acquiring an image; confirming that an entire display shelf or a part of the display shelf on which a target product is located is included in the acquired image; and outputting, to a display module, display data that emphasizes a location in which the target product is located on the display shelf on which the target product is located, after the confirmation is performed.

A fifth aspect relates to an information processing apparatus. The information processing apparatus according to the fifth aspect includes: an acquisition module acquiring identification information of one wireless apparatus of a plurality of wireless apparatuses, each of plurality of wireless apparatus being provided in different locations and respectively sending radio signals including identification information thereof; a confirmation module confirming, based on the acquired identification information of the wireless apparatus, a positional relationship between the wireless apparatus indicated by the acquired identification information and a display shelf on which a target product is located, by referring to a storage module that stores arrangement information of the plurality of wireless apparatuses and a plurality of display shelves; and a display processing module outputting to a display module display data that emphasizes a location in which the target product is located on the display shelf on which the target product is located, after the confirmation is performed.

A sixth aspect relates to a support method performed by a computer. The support method according to the sixth aspect includes: acquiring identification information of one wireless apparatus of a plurality of wireless apparatuses, each of plurality of wireless apparatus being provided in different locations and respectively sending radio signals including identification information thereof; confirming, based on the acquired identification information of the wireless apparatus, a positional relationship between the wireless apparatus indicated by the acquired identification information and a display shelf on which a target product is located, by referring to a storage module that stores arrangement information of the plurality of wireless apparatuses and a plurality of display shelves; and outputting, to a display module, display data that emphasizes a location in which the target product is located on the display shelf on which the target product is located, after the confirmation is performed.

Another aspect of the present invention may be a program causing at least one computer to perform the method of each of the second, fourth, and sixth aspects, or may be a storage medium storing the program capable of being read by the at least one computer. The storage medium includes a non-transitory tangible medium.

### Advantageous Effects of Invention

According to the aspects, it is possible to provide a technology for supporting a salesperson or a customer in a store.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a conceptual diagram illustrating a configuration example of a support system according to a first example embodiment.

FIG. 2 is a conceptual diagram illustrating a hardware configuration example of a server apparatus according to the first example embodiment.

FIG. 3 is a conceptual diagram illustrating a hardware configuration example of a mobile apparatus according to the first example embodiment.

FIG. 4 is a diagram illustrating an example of arrangement of beacon apparatuses.

FIG. 5 is a conceptual diagram illustrating a processing configuration example of the server apparatus according to the first example embodiment.

FIG. 6 is a diagram illustrating an example of an ordering time table.

FIG. 7 is a diagram illustrating an example of a person-in-charge table.

FIG. 8 is a diagram illustrating an example of a store layout table.

FIG. 9 is a diagram illustrating an example of a product information table.

FIG. 10 is a diagram illustrating an example of a product layout table.

FIG. 11 is a diagram illustrating a display example of a specified display shelf.

FIG. 12 is a conceptual diagram illustrating a processing configuration example of a mobile apparatus according to the first example embodiment.

FIG. 13 is a sequence chart illustrating an operation example of the support system according to the first example embodiment.

FIG. 14 is a sequence chart illustrating an operation example of the support system according to the first example embodiment.

FIG. 15 is a diagram illustrating a display example of information of an ordering candidate product and route information.

FIG. 16 is a conceptual diagram illustrating a processing configuration example of an information processing apparatus according to a second example embodiment.

FIG. 17 is a flowchart illustrating an operation example of the information processing apparatus according to the second example embodiment.

FIG. 18 is a conceptual diagram illustrating a processing configuration example of an information processing apparatus according to a third example embodiment.

FIG. 19 is a flowchart illustrating an operation example of the information processing apparatus according to the third example embodiment.

FIG. 20 is a conceptual diagram illustrating a processing configuration example of an information processing apparatus according to a fourth example embodiment.

FIG. 21 is a flowchart illustrating an operation example of the information processing apparatus according to the fourth example embodiment.

### DESCRIPTION OF EMBODIMENTS

Hereinafter, example embodiments of the present invention will be described. Note that, the example embodiments described to be below are merely examples, and the present invention is not limited to configurations of the following example embodiments.

### First Example Embodiment

[System Configuration]

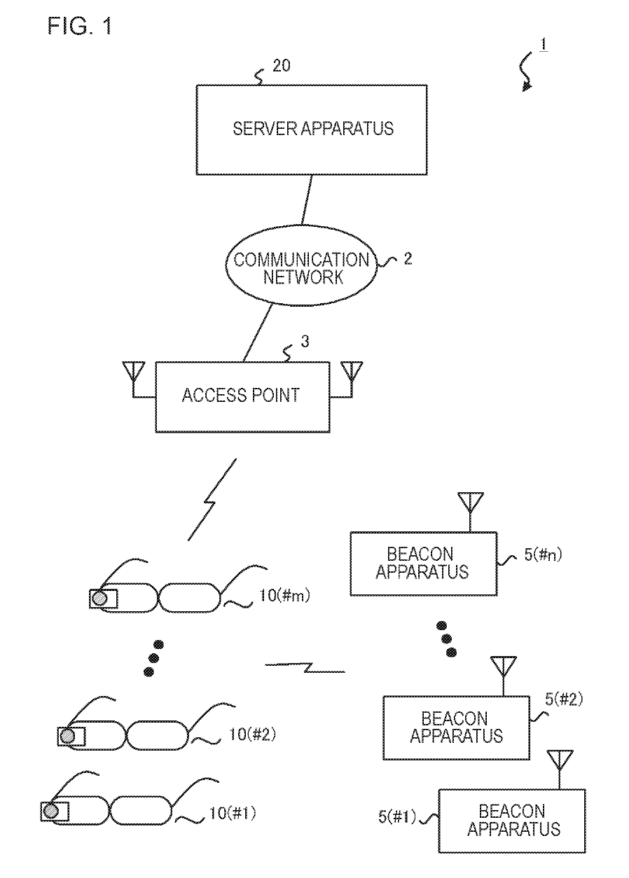

FIG. 1 is a conceptual diagram illustrating a configuration example of a support system 1 according to a first example embodiment. The support system 1 according to the first example embodiment includes a plurality of mobile apparatuses 10, a plurality of beacon apparatuses 5, an access point (AP) 3, and a server apparatus 20. The support system 1 supports operations of a store having a plurality of display shelves, in particular, an ordering operation. In the following description, “display shelf” and “shelf” are accurately distinguished. The “display shelf” means a rack and a cabinet that include at least one row of the “shelf”, and the “shelf” means an individual member that is included in the display shelf and on which products are displayed.

The plurality of beacon apparatuses 5 is provided in the store, and each salesperson has each mobile apparatus 10. Each mobile apparatuses 10 may receive radio signals transmitted from the beacon apparatuses 5, and may communicate with the server apparatus 20 through the AP 3 and a communication network 2. The specific contents of processes of each apparatus will be described below.

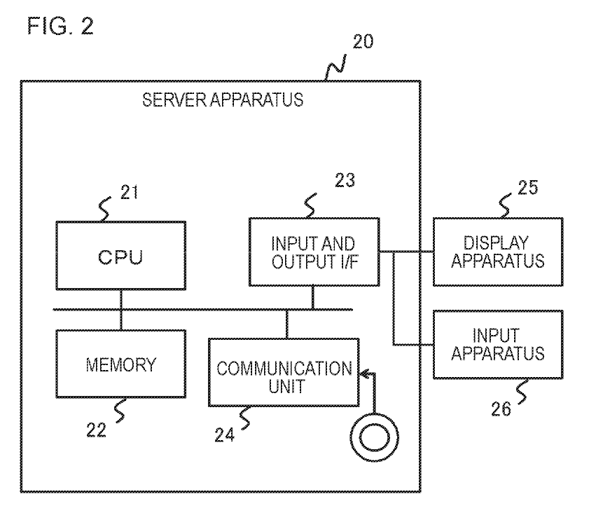

FIG. 2 is a conceptual diagram illustrating a hardware configuration example of the server apparatus 20 according to the first example embodiment. As illustrated in FIG. 2, the server apparatus 20 includes a central processing unit (CPU) 21, a memory 22, and an input and output interface (I/F) 23, and a communication unit 24. For example, these hardware elements are connected through a bus. The CPU 21 is equivalent to at least one of a general CPU, an integrated circuit (ASIC) for a specific purpose, a digital signal processor (DSP), and a graphics processing unit (GPU). The memory 22 is a random-access memory (RAM), a read-only memory (ROM), or an auxiliary storage apparatus (a hard disk or the like). The communication unit 24 communicates with another apparatus or another device in a wireless or wired manner. Specifically, the communication unit 24 is communicably connected to the communication network 2, and communicates with the mobile apparatuses 10 through the communication network 2 and the AP 3. The communication unit 24 may be connected to a portable storage medium.

A display apparatus 25 and an input apparatus 26 may be connected to the input and output I/F 23. The display apparatus 25 is an output apparatus such as a liquid crystal display (LCD) or a cathode ray tube (CRT) display that displays display information corresponding to drawing data processed by the CPU 21. The input apparatus 26 is an apparatus such as a keyboard or a mouse that receives an input of a user operation. The display apparatus 25 and the input apparatus 26 may be integrally provided, or may be implemented by a touch panel.

The communication network 2 is established by one or more communication networks such as a mobile phone network, a Wireless Fidelity (Wi-Fi) network, an Internet communication network, a dedicated network, and a local area network (LAN). In the example of FIG. 1, the AP 3 is also communicably connected to the communication network 2.

The AP 3 is wirelessly connected to the plurality of mobile apparatuses 10, and relays communication between the server apparatus 20 and each mobile apparatus 10. A communication form between the AP 3 and the communication network 2 is not limited. In the present example embodiment, a communication form between the server apparatus 20 and each mobile apparatus 10 is not limited.

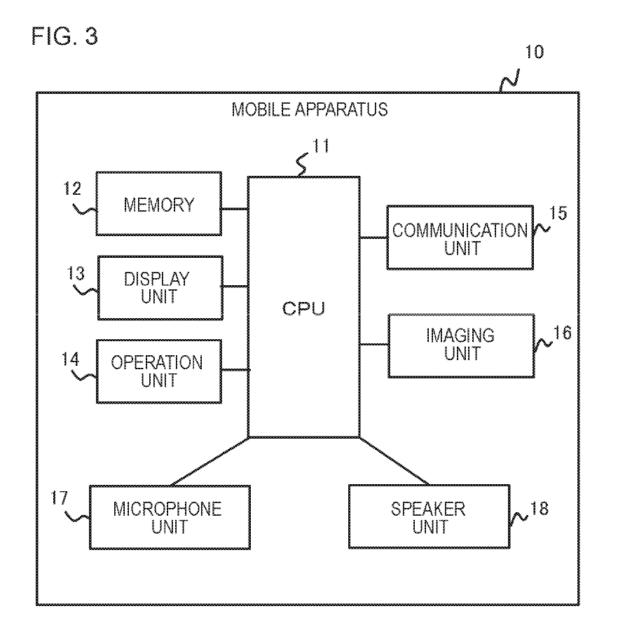

FIG. 3 is a conceptual diagram illustrating a hardware configuration example of the mobile apparatus 10 according to the first example embodiment. The mobile apparatus 10 according to the first example embodiment is a dedicated computer such as a so-called general-purpose computer such as a smartphone, a tablet terminal, or a wearable device or a graphic order terminal (GOT) that supports operations of a store. As illustrated in FIG. 1, the mobile apparatus 10 is preferably implemented by a wearable device, particularly, wearable glasses. Accordingly, since the mobile apparatus 10 does not occupies the salesperson's hand, the salesperson can more easily perform the operation.

The mobile apparatus 10 includes a CPU 11, a memory 12, a display unit 13, an operation unit 14, a communication unit 15, an imaging unit 16, a microphone unit 17, and a speaker unit 18. The CPU 11 and the memory 12 have the same as the CPU 21 and the memory 22. The CPU 11 is connected to the other hardware elements through a communication line such as a bus.

The display unit 13 includes a monitor such as a liquid crystal display (LCD) or a cathode ray tube (CRT) display, and performs a display process.

The operation unit 14 includes an operation module operated by a user, and performs a process of detecting an operation of the user. For example, the operation unit 14 includes a touch sensor that receives an operation input from the user by sensing a touch from the outside. The display unit 13 and the operation unit 14 may be implemented by a touch panel unit.

The communication unit 15 establishes a radio channel with the AP 3, and communicates with the server apparatus 20 through the AP 3 and the communication network 2. The communication unit 15 may communicate with another mobile apparatus 10 through the AP 3 or may directly communicate with another mobile apparatus. The communication unit 15 may receive a radio signal sent from each beacon apparatus 5.

The imaging unit 16 includes an imaging module, and acquires data of an image imaged by the imaging module.

The microphone unit 17 is a sound collection apparatus. The speaker unit 18 is a voice output apparatus. Although it has been described in the example of FIG. 3 that the operation unit 14, the imaging unit 16, and the microphone unit 17 are used as the hardware elements that may detect the user operation, the mobile apparatus 10 may include a vibration sensor, an acceleration sensor, and a geomagnetic sensor (all not illustrated) that may detect other kinds of user operations.

The beacon apparatus 5 is a wireless apparatus that is disposed in an arbitrary position within the store and sends a radio signal including identification information of the beacon apparatus in order to notify of the position thereof. For example, the beacon apparatus 5 uses a short-range wireless communication called Bluetooth (registered trademark) Low Energy (BLE). In this case, the identification information of the beacon apparatus 5 is proximity UUID (universally unique identifier), and the radio signal to be sent is an advertising packet. A wireless communication standard used by the beacon apparatus 5 is not limited to the BLE.

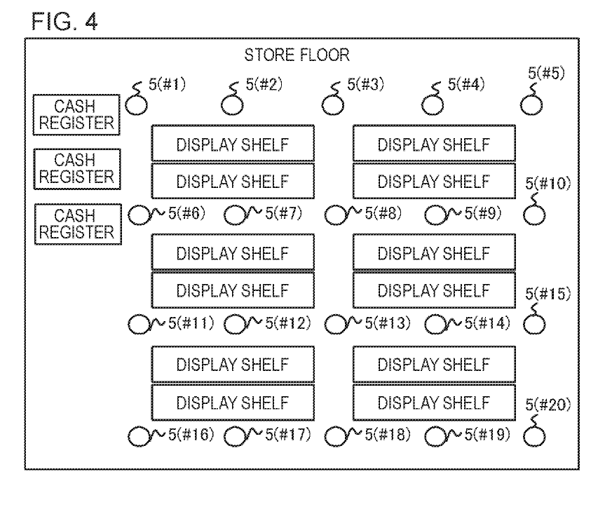

FIG. 4 is a diagram illustrating an example of the arrangement of the beacon apparatuses 5. FIG. 4 illustrates a plan view when the store is viewed from a ceiling, and 20 beacon apparatuses 5 are arranged on the ceiling of the store at constant intervals. In the present example embodiment, in order to detect a position of the salesperson with respect to the display shelf, the beacon apparatuses 5 are arranged around the display shelf at constant intervals. A form of the arrangement of the beacon apparatuses 5 is not limited to the example of FIG. 4. Some intervals between the beacon apparatuses 5 in the store may be partially widened or shortened. The arrangement of the beacon apparatuses 5 may be appropriately determined depending on the detection accuracy of the position of the salesperson.

The hardware configurations illustrated in FIGS. 2 and 3 are merely examples, and the hardware configurations of the mobile apparatus 10 and the server apparatus 20 are not limited to the examples illustrated in FIGS. 2 and 3. The mobile apparatus 10 and the server apparatus 20 may include other hardware elements (not illustrated). The number of apparatuses and the number of hardware elements of each apparatus are also not limited to the examples of FIGS. 1, 2, and 3. For example, the support system 1 may include a plurality of server apparatuses 20, and the server apparatus 20 and the mobile apparatus 10 may include a plurality of CPUs 21 (CPUs 11). The individual mobile apparatuses 10 and the individual beacon apparatuses 5 are respectively referred as reference numerals 10 and 5 except that it is necessary to particularly distinguish these apparatuses.

[Processing Configuration]

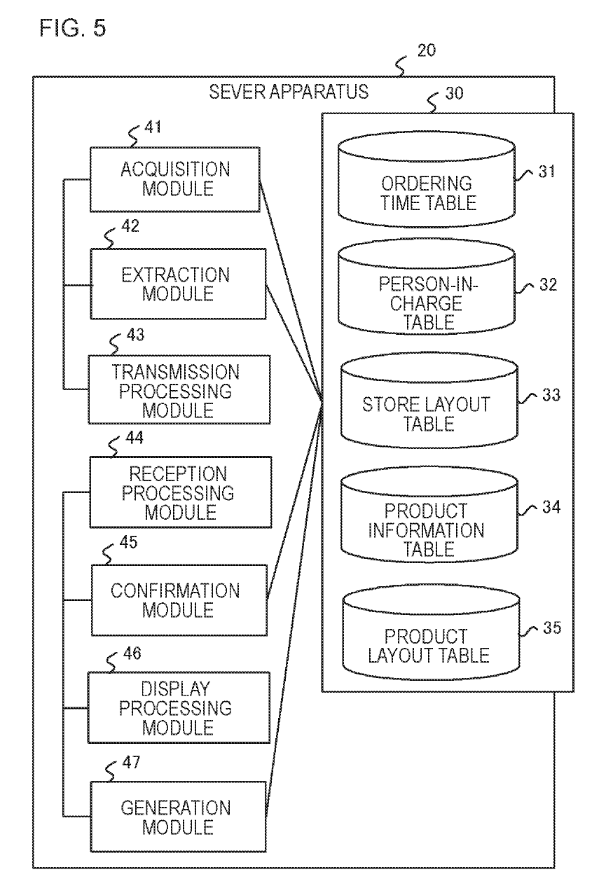

FIG. 5 is a conceptual diagram illustrating a processing configuration example of the server apparatus 20 according to the first example embodiment. The server apparatus 20 includes an acquisition module 41, an extraction module 42, a transmission processing module 43, a reception processing module 44, a confirmation module 45, a display processing module 46, a generation module 47, and a database 30. For example, a program stored in the memory 22 is executed by the CPU 21, and thus, the processing modules are implemented. For example, the program may be installed from a portable storage medium such as a compact disc (CD) or a memory card or another computer on a network through the communication unit 24, and may be stored in the memory 22.

The database 30 includes an ordering time table 31, a person-in-charge table 32, a store layout table 33, a product information table 34, and a product layout table 35.

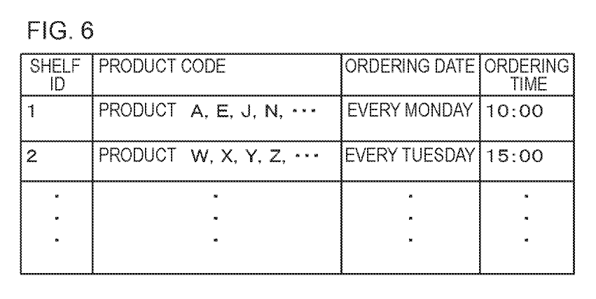

FIG. 6 is a diagram illustrating an example of the ordering time table. The ordering time table 31 stores a list of ordering dates and ordering times of products for every display shelf. A shelf ID is identification information for identifying a display shelf present in the store. A product code is identification information for identifying each product. The product code used in a point of sale (POS) system may be used as it is. In the example of FIG. 6, a “product code” field includes, for each display shelf, a list of product codes of products that are ordered in the same date. The ordering time table 31 is not limited to the example of FIG. 6. The ordering time table 31 is equivalent to a first storage module of the present invention.

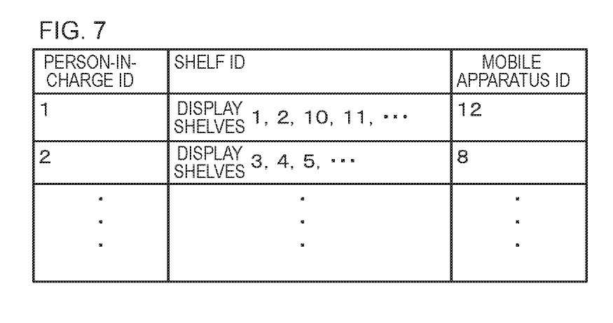

FIG. 7 is a diagram illustrating an example of the person-in-charge table 32. The person-in-charge table 32 stores, for each person in charge, IDs of display shelves managed and ID of the mobile apparatuses 10 held. A person-in-charge ID is identification information for identifying the person in charge who conducts the ordering operation in the store. A mobile apparatus ID is identification information for identifying the mobile apparatus 10 of the person in charge. An address that is a transmission destination address may be used as the mobile apparatus ID when the server apparatus 20 sends information to the mobile apparatus 10. Further, the mobile apparatus ID may be identification information that is a key for acquiring the transmission destination address. The person-in-charge table 32 is not limited to the example of FIG. 7. The person-in-charge table 32 is equivalent to a second storage module of the present invention.

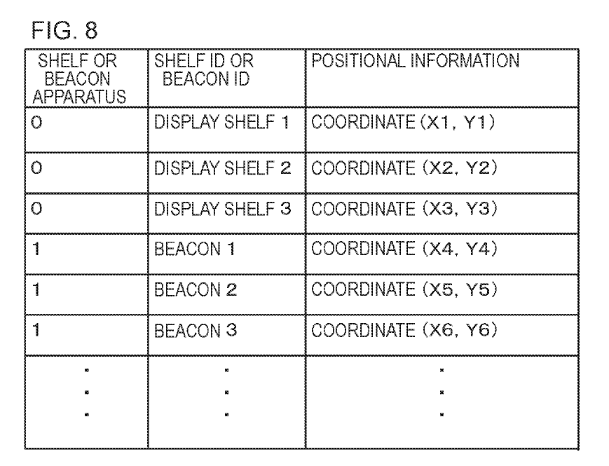

FIG. 8 is a diagram illustrating an example of the store layout table 33. The store layout table 33 stores the display shelves and information items indicating positions of the beacon apparatuses 5 in the store. In the example of FIG. 8, flag data (0 or 1) for distinguishing whether this record indicates information of the display shelf or indicates information of the beacon apparatus is stored in a field of “shelf or beacon apparatus”. A field of “shelf ID or beacon ID” stores the shelf ID or a beacon ID, which is for identifying each beacon apparatus 5. The positional information indicates position coordinates on a floor plane (plan view) of the store. The positional information is used for providing a route reaching a certain display shelf to the salesperson. Thus, as the positional information, it may be used position coordinate on an image for which the route is indicated or may be used real world coordinate that is represented by latitude and longitude. The positional information may show a relative positional relationship between the beacon apparatus 5 and the display shelf. For example, the positional information of the beacon apparatus 5 is represented by a front side, a front right end, or a front left end of a certain display shelf. The store layout table 33 is not limited to the example of FIG. 8. The store layout table 33 is equivalent to a third storage module of the present invention.

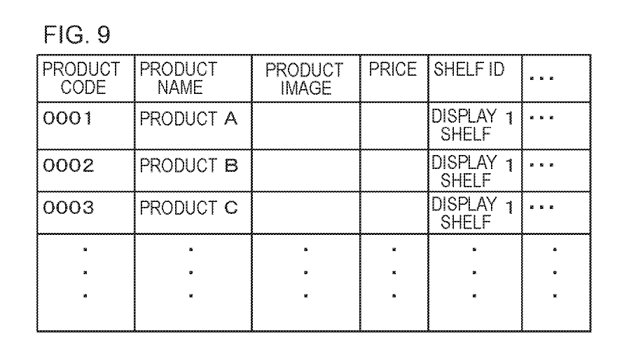

FIG. 9 is a diagram illustrating an example of the product information table 34. The product information table 34 stores information items of products displayed on a product shelf. As illustrated in FIG. 9, product image information and the shelf ID are included in each record of the product information table 34. The product image information may be image information used for identifying products included in an image imaged by the mobile apparatus 10, and may be image data or feature value information of the image. The shelf ID is identification information for identifying the display shelf on which the product is displayed. The product information table 34 may be shared with the POS system. In this case, the POS system may acquire product information such as price or the like from the product information table 34. The product information table 34 is not limited to the example of FIG. 9.

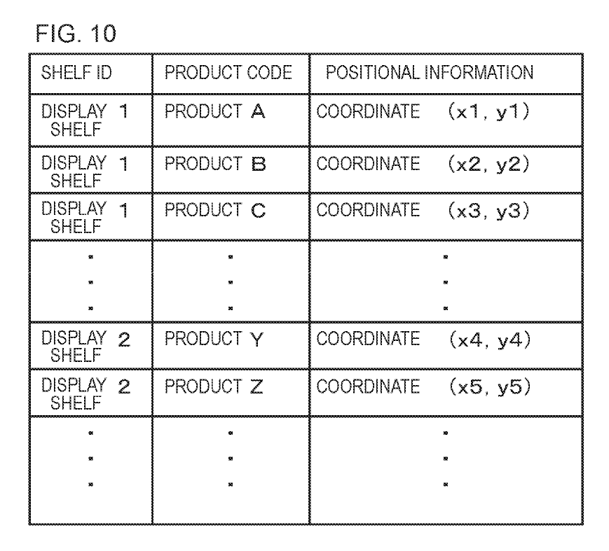

FIG. 10 is a diagram illustrating an example of the product layout table 35. The product layout table 35 stores information indicating a layout of products for each display shelf. In the example of FIG. 10, the shelf ID, the product codes of the products located on the display shelf identified by the ID, and positional information items indicating the positions of the products on the display shelf are associated with each other, and the associated product codes and positional information items are stored. The positional information is represented by a coordinate on two axes in the height direction and the width direction of the display shelf in a front view. For example, given that the displayed product is viewed from the front side, the positional information may be represented by the center coordinate of its bottom, or may be represented by two coordinates indicating the two ends of its the bottom. Further, the positional information may represent the height direction by the arrangement orders of the shelves in the display shelf such as “the shelf is n-th one from the top”, and may represent the width direction by the arrangement orders of the products displayed on the same shelf such as “the shelf is n-th one from the left”. The product layout table 35 is not limited to the example of FIG. 10.

The acquisition module 41 acquires information of the display shelf on which ordering candidate products are to be displayed based on the relationship between the ordering time stored in the ordering time table 31 and the current time. Specifically, the acquisition module 41 monitors the relationship between the current date and time, the ordering date and the ordering time (hereinafter, may be referred to be an ordering timing) stored in the ordering time table 31, and detects that the ordering timing stored in the ordering time table 31 approaches. For example, the acquisition module 41 detects that a predetermined time (for example, three hours) left before the ordering timing. The acquisition module 41 extracts the shelf ID indicated by the record for which the predetermined time is left before the ordering timing, from the ordering time table 31. The acquisition module 41 may acquire information items of the plurality of display shelves.

The acquisition module 41 may further acquire information items of the ordering candidate products. Specifically, the acquisition module 41 extracts the product code indicated by the record the ordering timing of which approaches, from the ordering timetable 31. The “ordering candidate product” means a product the ordering timing of which approaches. The salesperson who is a person in charge of ordering goes to see the shelf on which the “ordering candidate products” are displayed, and determines whether or not to order the products, the number of the products to be ordered, etc., in consideration of the number of displayed “ordering candidate products” or the number of stocked “ordering candidate products”.

The extraction module 42 extracts person-in-charge information of the display shelf indicated by the information acquired by the acquisition module 41 from the person-in-charge table 32. In the example of FIG. 7, the extraction module 42 extracts, as the person-in-charge information from the person-in-charge table 32, the person-in-charge ID and the mobile apparatus ID that are associated with the shelf ID acquired by the acquisition module 41.

The extraction module 42 may further extract the product information items related to the ordering candidate products indicated by the information acquired by the acquisition module 41 from the product information table 34. In this case, the extraction module 42 extracts the information items of the products associated with the product codes of the ordering candidate products acquired by the acquisition module 41 from the product information table 34.

The transmission processing module 43 transmits the information of the display shelf acquired by the acquisition module 41 together with an alert, to the mobile apparatus 10 held by the salesperson indicated by the person-in-charge information extracted by the extraction module 42. In a case where ordering times related to a plurality of display shelves managed by one person in charge approach, the transmission processing module 43 transmits the information items of the plurality of display shelves. The mobile apparatus 10 that receives the information displays the information of the display shelf. The transmitted information of the display shelf includes at least identification information of each display shelf.

The transmission processing module 43 transmits route information generated by the generation module 47 described later to the mobile apparatus 10 that is a transmission destination of the information of the above-mentioned display shelf. The mobile apparatus 10 that receives the route information displays a route from the beacon apparatus 5 nearest to the display shelf of the product the ordering time of which approaches. In this case, the transmission processing module 43 may further transmit the product information extracted by the extraction module 42. Accordingly, the mobile apparatus 10 may display the information items of the ordering candidate products together with the route information.

The reception processing module 44 receives the identification information of one beacon apparatus 5 of the plurality of beacon apparatuses 5 and the identification information of the display shelf specified by the mobile apparatus 10 from the mobile apparatus 10. The received identification information of the beacon apparatus 5 indicates the beacon apparatus 5 nearest to the mobile apparatus 10 to which the transmission processing module 43 transmits the information of the display shelf. The received identification information of the display shelf indicates the display shelf selected by the user (person in charge) who has the mobile apparatus 10, among the display shelves indicated by the information transmitted by the transmission processing module 43. Hereinafter, the display shelf selected by the user of the mobile apparatus 10 may be referred to as the specified display shelf. In other words, the specified display shelf is the display shelf specified by the user of the mobile apparatus 10 among the display shelves on which the ordering candidate products are displayed.

In a case where only one display shelf is determined by every person in charge, the specification using the mobile apparatus 10 is not necessary. In this case, the reception processing module 44 may receive only the identification information of the beacon apparatus 5, or may receive the identification information of the beacon apparatus 5 and the identification information of the display shelf. As stated above, irrespective of whether or not the specification in the mobile apparatus 10 is performed, one display shelf determined for one person in charge (one mobile apparatus 10) is also referred to as the specified display shelf. The reception processing module 44 receives the image imaged by the mobile apparatus 10 from the mobile apparatus 10.

The generation module 47 refers to the store layout table 33 based on the identification information of the beacon apparatus 5 received by the reception processing module 44, and generates the route information from the beacon apparatus 5, which is indicated by the identification information received by the reception processing module 44, to the specified display shelf. When the identification information of the display shelf is received by the reception processing module 44, the specified display shelf is determined by the identification information. When the identification information of the display shelf is not received by the reception processing module 44, the specified display shelf is determined by the identification information included in the information acquired by the acquisition module 41. As illustrated in FIG. 8, arrangement information of the beacon apparatuses 5 and the display shelves is stored in the store layout table 33. Thus, with referring to the arrangement information thereof, the generation module 47 may determine the shortest route between the specified display shelf and the beacon apparatus 5 nearest to the person in charge, by using a well-known route searching technology used in an existing automotive navigation system or a direction guidance application for pedestrians. For example, the route information generated by the generation module 47 is represented by the same coordinate information as the positional information stored in the store layout table 33.

The confirmation module 45 confirms that the entire specified display shelf or a part thereof is included in the image sent from the mobile apparatus 10. The confirmation is to confirm that the person in charge who has the mobile apparatus 10 is located in front of the specified display shelf. The confirmation module 45 performs the confirmation processes described above by collating the product image included in the image sent from the mobile apparatus 10 with the image of the product located in the specified display shelf. The collating of the two images includes computation of a degree of similarity between feature values of the images. Through the collating of the images, the confirmation module 45 confirms that the entire specified display shelf or a part thereof is included in the image by confirming that one or more products located in the specified display shelf are included in the image sent from the mobile apparatus 10.

For example, by using a well-known image recognition method, the confirmation module 45 may detect the shelf or frame of the specified display shelf from the image, and may detect an image area representing the displayed product based on the positional relationship with the shelf or frame. The confirmation module 45 extracts the product code and the positional information of each product associated with the shelf ID of the specified display shelf from the product layout table 35, and extracts the product image information associated with the extracted product code from the product information table 34. The confirmation module 45 collates the image area of the product detected as described above with each of extracted product image information. In a case where the image area of the product having a degree of similarity with the extracted product image information is equal to or greater than a predetermined threshold is detected, the confirmation module 45 may confirm that this image is an image acquired by imaging the entire specified display shelf and a part thereof. The confirmation module 45 may use only the image information of the ordering candidate products located on the specified display shelf as a collating target, or may use the image information of the plurality of products (may include the ordering candidate products) located on the specified display shelf, as the collating target.

After the confirmation is performed by the confirmation module 45, the display processing module 46 outputs display data in which a location at which an ordering candidate product is displayed on the specified display shelf, to the mobile apparatus 10. For example, the display processing module 46 generates image data emphasizing the images of the ordering candidate products on the image of the specified display shelf on which the products are displayed in predetermined locations, and sends the image data to the mobile apparatus 10. In this case, the display processing module 46 may determine the locations of the images of the ordering candidate products in the image data by using the positional information extracted from the product layout table 35. The emphasizing display method is not limited as long as the image data is displayed such that the locations in which the ordering candidate products are displayed are able to be distinguished from locations in which other products are displayed. For example, there are various emphasizing display methods such as the flicker of the ordering candidate product, a change of a display color of the ordering candidate product, and the giving of a specific mark to the ordering candidate product.

The display processing module 46 may output display data acquired by superimposing an additional image in which the ordering candidate products are emphasized on the image imaged by the mobile apparatus 10 to the mobile apparatus 10 by using a well-known augmented reality (AR) technology. The display processing module 46 displays the image acquired by superimposing any additional image on the location of the imaged image in which the ordering candidate product is located on the mobile apparatus 10. In a case where the mobile apparatus 10 is implemented by a video see-through display type or optical see-through type head-mounted display or wearable display, the display processing module 46 may output display data emphasizing the location in which the ordering candidate product is located is emphasized on the specified display shelf to the mobile apparatus 10 by sending drawing data of the emphasized display data and positional information thereof to the mobile apparatus 10. In this case, at least one of the positional information extracted from the product layout table 35 and the product image information extracted from the product information table 34 is used in the determining of the location in which the ordering candidate product is located. In a case where the ordering candidate product remains in the specified display shelf, it is possible to determine the location in which the ordering candidate product is located by comparing the product image information of the ordering candidate product with the image area representing the product in the image. In a case where the ordering candidate product does not remain in the specified display shelf, it is possible to determine the location in which the ordering candidate product is located by using the extracted positional information.

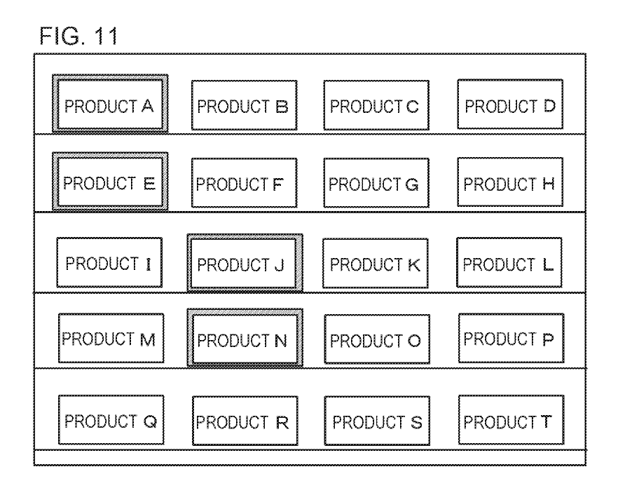

FIG. 11 is a diagram illustrating a display example of the specified display shelf. In the example of FIG. 11, four products are displayed on each shelf with five rows, and the ordering candidate products “product A”, “product E”, “product J”, and “product N” of all the displayed products are emphasized and displayed. In the example of FIG. 11, the location in which the ordering candidate product is located is emphasized by highlighting peripheral portions of the ordering candidate products.

On the other hand, in a case where the entire specified display shelf or a part thereof is not included in the image sent from the mobile apparatus 10, the person in charge who has the mobile apparatus 10 is likely to image a wrong display shelf. Thus, in a case where the confirmation module 45 is not able to confirm that the entire specified display shelf or a part thereof is included in the image sent from the mobile apparatus 10, the display processing module 46 may display information indicating that the confirmation is not able to be performed on the mobile apparatus 10. Through the displaying of such information, the person in charge can recognize that the imaged display shelf is not the specified display shelf, and can rapidly move to a correct display shelf.

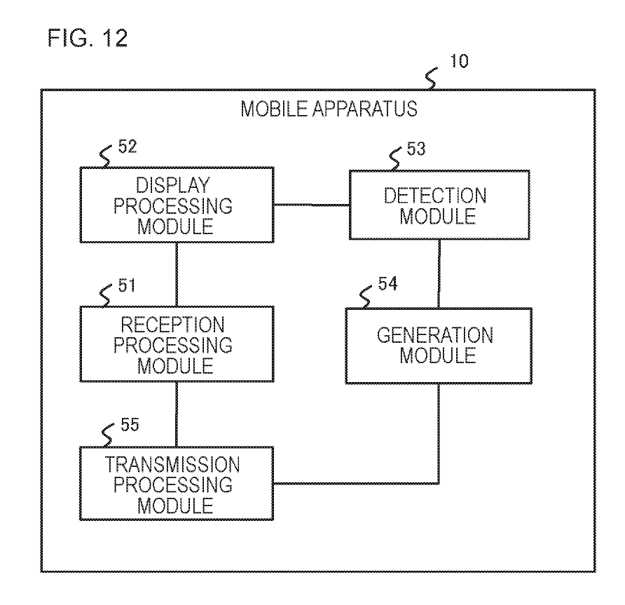

FIG. 12 is a conceptual diagram illustrating a processing configuration example of the mobile apparatus 10 according to the first example embodiment. The mobile apparatus 10 includes a reception processing module 51, a display processing module 52, a detection module 53, a generation module 54, and a transmission processing module 55. For example, the CPU 11 executes a program stored in the memory 12, and thus, these processing modules are implemented. For example, the program may be installed from a portable storage medium such as a CD or a memory card or another computer on a network through the communication unit 15, and may be stored in the memory 12.

The reception processing module 51 receives data items sent from the transmission processing module 43 and the display processing module 46 of the server apparatus 20. Specifically, the reception processing module 51 receives information of the product shelf which is transmitted from the transmission processing module 43 of the server apparatus 20 and on which the ordering candidate products are located. The reception processing module 51 receives the product information of the ordering candidate product and the route information transmitted from the transmission processing module 43 of the server apparatus 20. The reception processing module 51 receives display data sent from the display processing module 46 of the server apparatus 20.

The reception processing module 51 receives the radio signal sent from the beacon apparatus 5. The reception processing module 51 extracts the identification information of the beacon apparatus 5 from the received radio signal. The reception processing module 51 may measure the radio wave intensity of the received radio signal. Accordingly, the reception processing module 51 may determine the identification information of the nearest beacon apparatus 5. The reception processing module 51 determines, as the nearest beacon apparatus 5, the beacon apparatus 5 indicated by the identification information extracted from the radio signal the radio wave intensity of which is the highest.

The display processing module 52 displays the information of the product shelf on which the ordering candidate product is located together with the alert on a monitor of the display unit 13 based on the information received by the reception processing module 51. In a case where the received information indicates the plurality of product shelves, the display processing module 52 displays a list of product shelves.

The display processing module 52 displays the route from the beacon apparatus 5 nearest to the specified display shelf based on the route information received by the reception processing module 51. In a case where the information of the ordering candidate product together with the route information is received, the display processing module 52 may display the information of the ordering candidate product together with the route.

The display processing module 52 outputs display data emphasizing the location in which the ordering candidate product is located on the specified display shelf to the monitor of the display unit 13 based on the display data sent from the display processing module 46 of the server apparatus 20. The display processing module 52 includes a WEB browser installed in the mobile apparatus 10, may acquire Hypertext Markup Language (HTML) data from the server apparatus 20, and may output display information indicating various information items based on the HTML data (WEB browser). The interface between the display processing module 52 and the display processing module 46 of the server apparatus 20 and the method of outputting the display information are not limited.

The detection module 53 detects the operation of the user (person in charge) related to the display information output by the display processing module 52. Specifically, the detection module 53 detects the operation for selecting one display shelf in the display information of the display shelf. The detection module 53 may detect an operation performed through the voice of the user. That is, the detection module 53 may acquire the information of the selected display shelf by recognizing the voice of the user acquired by the microphone unit 17. The display shelf selected through such an operation is the specified display shelf. The detection module 53 detects an operation for selecting the ordering candidate product in the display data that emphasizes the location in which the ordering candidate product is located on the specified display shelf.

The generation module 54 generates ordering information of the product based on the operation detected by the detection module 53. For example, the generation module 54 generates ordering information including the product code of the ordering candidate product selected by the user and the number of products to be ordered. For example, the product code may be included in the display data, and the generation module 54 may acquire the product code from the display data. For example, the number of products to be ordered is input through the input operation of the user performed on an input screen which is output while being superimposed on the display information. The number of products to be ordered may be acquired by recognizing the voice of the user acquired by the microphone unit 17.

The transmission processing module 55 transmits the identification information of the nearest beacon apparatus 5 and the identification information of the specified display shelf to the server apparatus 20. The transmission processing module 55 transmits the image imaged by the imaging unit 16 to the server apparatus 20. The imaging unit 16 may image the image at a timing when a predetermined operation (including an operation performed through the voice) performed by the user is detected, or the imaging unit may image the image at predetermined cycles.

In a case where the ordering information is generated by the generation module 54, the transmission processing module 55 transmits the generated ordering information. A transmission destination of the ordering information is an apparatus that performs an ordering process. In a case where the server apparatus 20 performs the ordering process, the transmission processing module 55 transmits the ordering information to the server apparatus 20. The transmission processing module 55 may transmit the ordering information to an ordering terminal such as GOT by using the short-range wireless communication of the communication unit 15.

### OPERATION EXAMPLE

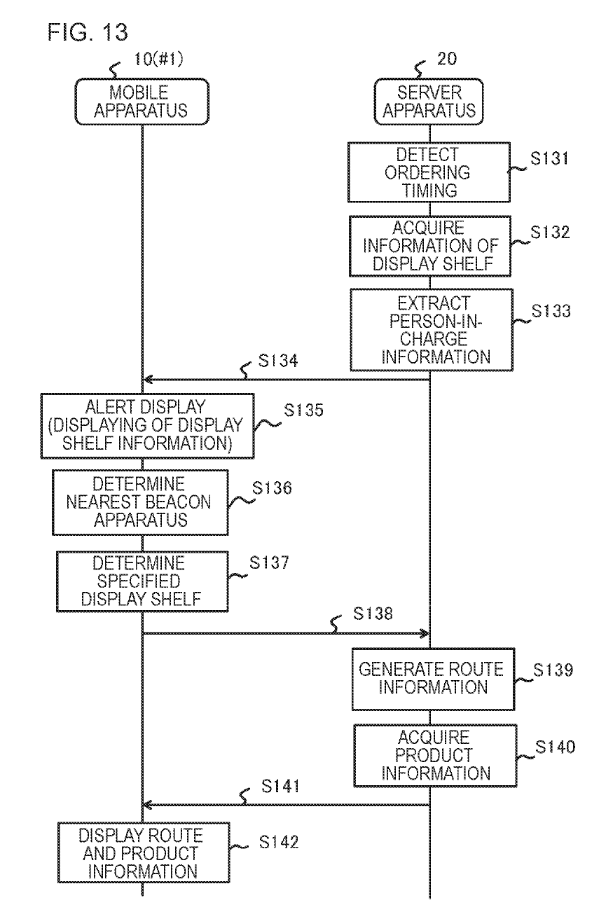

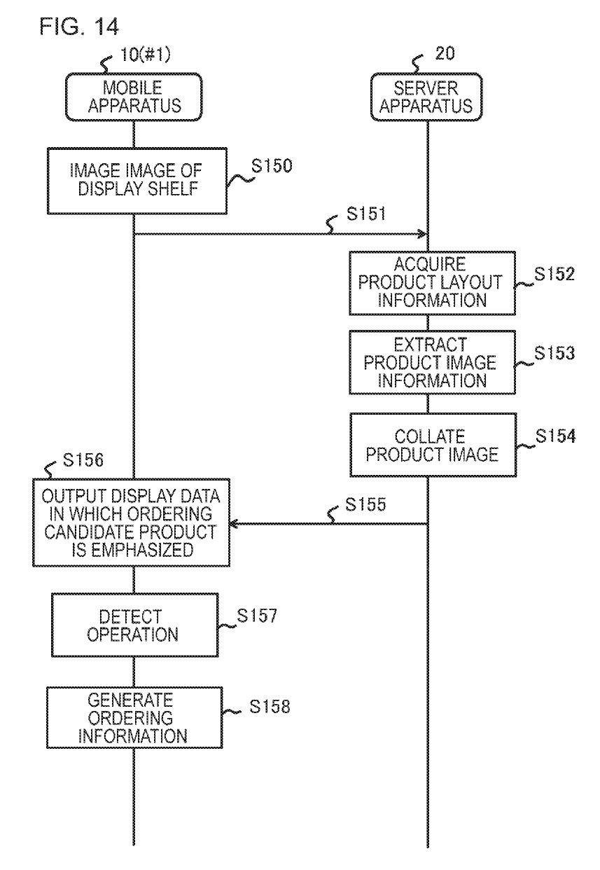

Hereinafter, an ordering support method according to the first example embodiment will be described with reference to FIGS. 13 and 14. FIGS. 13 and 14 are sequence charts illustrating an operation example of the support system 1 according to the first example embodiment. As illustrated in FIGS. 13 and 14, the ordering support method according to the first example embodiment is performed by a plurality of computers such as the mobile apparatus 10 and the server apparatus 20. For example, the illustrated steps are performed by the processing modules of the mobile apparatus 10 and the server apparatus 20. The processing contents of the steps are the same as those of the apparatuses, and thus, the details of the steps are appropriately not described.

The server apparatus 20 monitors the relationship between the ordering date and the ordering time (ordering timing) stored in the ordering time table 31 and the current ordering date and time, and detects an ordering timing approaching in a predetermined time (S131). The server apparatus 20 retains the predetermined time in advance.

The server apparatus 20 acquires the information of the display shelf corresponding to the ordering timing approaching in the predetermined time (S132). For example, the server apparatus 20 extracts the shelf ID indicated by the record the ordering timing of which is within the predetermined time from the ordering time table 31. In this case, the server apparatus 20 may extract the product code included in the same record. The product code indicates the ordering candidate product the ordering timing of which approaches.

The server apparatus 20 extracts the information of the person in charge who manages the display shelf indicated by the information acquired in (S132) from the person-in-charge table 32 (S133). For example, the server apparatus 20 extracts the person-in-charge ID and the mobile apparatus ID associated with the shelf ID acquired in (S132), as the person-in-charge information, from the person-in-charge table 32. In the examples of FIGS. 13 and 14, it is assumed that the information of the person in charge person (salesperson) who has the mobile apparatus 10(#1) is extracted.

The server apparatus 20 transmits an alert notification to the mobile apparatus 10(#1) of the person in charge indicated by the person-in-charge information extracted in (S133) (S134). The server apparatus 20 transmits the information of the display shelf acquired in (S132) together with the alert notification to the mobile apparatus 10 (S134). The information of the display shelf to be transmitted includes at least identification information of each display shelf. The mobile apparatus ID extracted as the person-in-charge information in (S133) or the apparatus address determined from the mobile apparatus ID may be used as a transmission destination address. In a case where the person-in-charge ID is a mail address, the alert notification may be transmitted to an electronic mail of the person-in-charge ID.

If the alert notification and the information of the display shelf are received, the mobile apparatus 10(#1) displays the alert together with the information of the display shelf (S135). Through the displaying of the alert, the person in charge (salesperson) who has the mobile apparatus 10(#1) can recognize that there is the product the ordering timing of which approaches among the products on the display shelf managed by this person in charge who is in charge of the ordering operation.

In this case, the mobile apparatus 10(#1) determines the nearest beacon apparatus 5 (S136). For example, the mobile apparatus 10(#1) determines, as the nearest beacon apparatus 5, the beacon apparatus 5 indicated by the identification information extracted from the radio signal the radio wave intensity of which is the highest.

The mobile apparatus 10(#1) determines the identification information of the display shelf selected by the person in charge from the information of the display shelf displayed in (S135) (S137). The mobile apparatus 10(#1) may detect the selection of the display shelf performed by the person in charge by the operation unit 14, or may detect the selection of the display shelf from the voice acquired by the microphone unit 17. That is, the mobile apparatus 10(#1) determines the identification information of the specified display shelf. In a case where the information received in (S134) indicates one display shelf, the mobile apparatus 10(#1) may determine the identification information of the display shelf even though an explicit selection operation is not performed by the person in charge.

The mobile apparatus 10(#1) transmits the identification information of the nearest beacon apparatus 5 determined in (S136) and the identification information of the specified display shelf determined in (S137) to the server apparatus 20 (S138).

If the identification information of the nearest beacon apparatus 5 and the identification information of the specified display shelf are received from the mobile apparatus 10(#1), the server apparatus 20 generates the route information from the nearest beacon apparatus 5 to the specified display shelf (S139). In this case, the server apparatus 20 refers to the store layout table 33 that stores the arrangement information of the beacon apparatuses 5 and the display shelves, and generates the route information by using the well-known route searching technology.

The server apparatus 20 extracts the information of the ordering candidate product located on the specified display shelf from the product information table 34. The server apparatus 20 acquires the product code associated with the shelf ID of the specified display shelf in the record of the ordering time table 31 determined in (S132). Since this product code indicates the ordering candidate product, the server apparatus 20 may acquire the information of the ordering candidate product from the product information table 34 by using the product code.

The server apparatus 20 transmits the route information generated in (S139) and the information of the ordering candidate product acquired in (S140) to the mobile apparatus 10 (#1) which is a transmission destination of (S134) and is a transmission source of (S138) (S141).

If the route information and the information of the ordering candidate product are received, the mobile apparatus 10(#1) displays the route from the nearest beacon apparatus 5 to the specified display shelf and the information of the ordering candidate product based on the information items (S142).

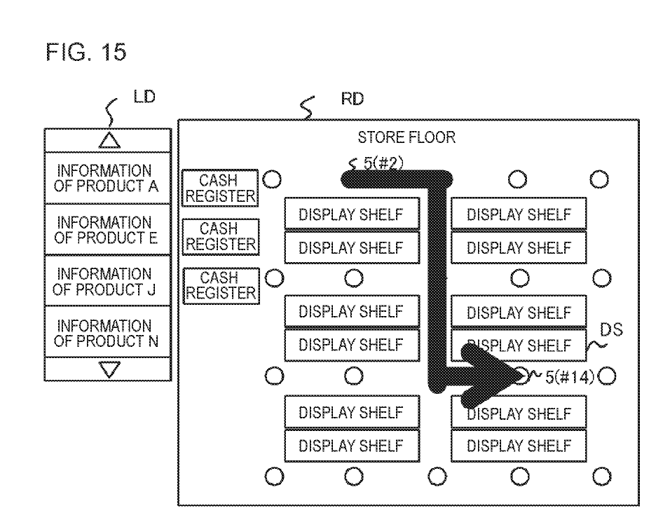

FIG. 15 is a diagram illustrating a display example of the information of the ordering candidate product and the route information. In the example of FIG. 15, the mobile apparatus 10 displays a display area RD of the route information and a display area LD of the information items of the ordering candidate products side by side. Information items of four ordering candidate products located on the specified display shelf are displayed in the display area LD. The shortest route from the nearest beacon apparatus 5(#2) to a specified display shelf DS is displayed by an arrow in the display area RD.

Through the displaying in (S135), the person in charge (salesperson) who has the mobile apparatus 10(#1) recognizes that there is the display shelf the ordering timing of which approaches, and specifies the display shelf, among the displayed display shelves, to which the person in charge will move. The display shelf may be specified by the operation unit 14 of the mobile apparatus 10(#1), or may be specified by the voice. Accordingly, the specified display shelf is determined in the mobile apparatus 10(#1). Thereafter, the person in charge can know the method of moving to the specified display shelf from a current position by viewing the route information displayed on the mobile apparatus 10(#1). In addition, the person in charge can know the information of the ordering candidate product displayed on the specified display shelf by viewing the product information displayed on the mobile apparatus 10(#1).

The person in charge moves to the specified display shelf while viewing the route information, operates the mobile apparatus 10(#1), and images the specified display shelf. Accordingly, the mobile apparatus 10(#1) images the image of the specified display shelf (S150). The image includes the entire specified display shelf or a part thereof. The mobile apparatus 10(#1) transmits the imaged image to the server apparatus 20 (S151).

If the image is received from the mobile apparatus 10(#1), the server apparatus 20 confirms that the entire specified display shelf or a part thereof is included in the image. For example, the server apparatus 20 detects the image area showing the displayed products from the image. The server apparatus 20 extracts the positional information and the product code of each product associated with the shelf ID of the specified display shelf from the product layout table 35 (S152). The server apparatus 20 extracts the product image information associated with the extracted product code from the product information table 34 (S153). The server apparatus 20 collates the image area of the products detected from the image with the product image information extracted in (S153) (S154). In a case where the image area of the product having a degree of similarity with the extracted product image information equal to or greater than a predetermined threshold is detected, the server apparatus 20 may confirm that this image is the image acquired by imaging the entire specified display shelf or a part thereof.

The server apparatus 20 outputs display data emphasizing the location in which the ordering candidate product is located on the specified display shelf to the mobile apparatus 10(#1) after the confirmation is performed (S155). For example, the server apparatus 20 generates the image data in which the image of the ordering candidate product is emphasized on the image of the specified display shelf on which the products are displayed in predetermined locations, and sends the image data to the mobile apparatus 10. The server apparatus 20 may send the drawing data of the emphasized display and the positional information to the mobile apparatus 10.

The mobile apparatus 10(#1) outputs the display data in which the ordering candidate product is emphasized based on the data received from the server apparatus 20 (S156). Accordingly, the display illustrated in FIG. 11 is output. The person in charge who views this display can immediately recognize the location of the specified display shelf in which the ordering candidate product is located, and can immediately count the number of displayed products. Therefore, the person in charge can efficiently perform an ordering operation.

On the other hand, in a case where the server apparatus 20 is not able to confirm that the entire specified display shelf or a part thereof is included in the image sent from the mobile apparatus 10(#1), the server apparatus may display information indicating that the server apparatus is not able to confirm that the entire specified display shelf or a part thereof is included in the image to the mobile apparatus 10(#1) (S155). The mobile apparatus 10(#1) displays an error message of the information indicating that the server apparatus is not able to confirm that the entire specified display shelf or a part thereof is included in the imaged image (S156). Accordingly, the person in charge can recognize that the person in charge moves to another display shelf other than the specified display shelf, and can rapidly start to move to a correct specified display shelf.

The mobile apparatus 10(#1) detects the operation of the person in charge related to the display output in (S156) (S157). For example, the mobile apparatus 10(#1) detects an operation for selecting the ordering candidate product or an operation for inputting the number of ordering candidate products to be ordered in the display data emphasizing the location in which the ordering candidate product is located on the specified display shelf. Such an operation may be detected by the operation unit 14 or may be detected from the voice acquired by the microphone unit 17.

The mobile apparatus 10(#1) generates the ordering information of the product selected among the ordering candidate products based on the operation detected in (S157) (S158). For example, the mobile apparatus 10(#1) generates the ordering information including the product code of the ordering candidate product selected by the user and the number of products to be ordered. The mobile apparatus 10(#1) transmits the ordering information generated in (S157) to the apparatus that performs the ordering process. In a case where the server apparatus 20 performs the ordering process, the mobile apparatus 10(#1) transmits the ordering information to the server apparatus 20. The mobile apparatus 10(#1) may transmit the ordering information to an ordering terminal such as GOT by using the short-range wireless communication of the communication unit 15.

The performing order of the processes performed in the support system 1 according to the first example embodiment is not limited to the examples of FIGS. 13 and 14. The performing order of the processes may be changed without hindrance on the contents. For example, (S136) may be sequentially performed at predetermined cycles. (S152) and (S153) may be performed before (S151) after the identification information of the specified display shelf is acquired in (S138).

[Advantages Effects of First Example Embodiment]

As described above, in the first example embodiment, the ordering timing of the product for every display shelf is stored in the ordering time table 31, and the ordering timing approaching within the predetermined time is detected through the monitoring for each ordering timing. The information of the display shelf managed by each person in charge is stored in the person-in-charge table 32, and the information of the person in charge who manages the display shelf corresponding to the detected ordering timing is extracted. An alert indicating that the ordering timing approaching within the predetermined time is detected is notified to the mobile apparatus 10 of the person in charge based on the extracted person-in-charge information, and the information of the display shelf corresponding to the detected ordering timing is transmitted.

In the store that handles various products, products to be ordered may be different for every selling section and for every day of week, or the ordering time may be different for every product. Thus, there is a concern that the person in charge who is not used to the ordering operation misses the ordering timing. According to the first example embodiment, the person in charge who has the mobile apparatus 10 can know that there is the ordering candidate product on which the ordering operation is to be performed within a predetermined time among the products on the display shelf managed by the person in charge before the ordering timing approaches. As a result, it is possible to prevent any person in charge from missing the ordering timing.

In the first example embodiment, the identification information of the beacon apparatus 5 nearest to the mobile apparatus 10 is sent to the server apparatus 20, the route information from the nearest beacon apparatus 5 to the specified display shelf is generated in the server apparatus 20, and the route information is displayed in the mobile apparatus 10. Accordingly, even the person in charge who does not remember the layout within the store can easily know a way to the specified display shelf from the current position. In a case where there is the plurality of display shelves the ordering timing of which approaches for one person in charge, a list of the information items of these display shelves is displayed on the mobile apparatus 10, and the identification information of one display shelf (specified display shelf) selected in the mobile apparatus 10 is sent to the server apparatus 20. Accordingly, the route from the current position to the specified display shelf indicated by the identification information is displayed on the mobile apparatus 10.

In the first example embodiment, the image imaged in the mobile apparatus 10 is sent to the server apparatus 20, and the server apparatus 20 confirms whether or not the entire specified display shelf or a part thereof is included in the image. After the confirmation, the display data emphasizing the location in which the ordering candidate product is located on the specified display shelf is output to the mobile apparatus 10. Accordingly, the person in charge who has the mobile apparatus 10 images the display shelf by using the mobile apparatus 10, and thus, the person in charge can confirm whether or not the person in charge correctly moves to the specified display shelf. Further, the person in charge can immediately recognize the location of the specified display shelf in which the ordering candidate product is located. The person in charge can immediately recognize that the person in charge moves to another display shelf different from the specified display shelf by viewing an error message indicating that the confirmation module is not able to confirm that the entire specified display shelf or a part thereof is included in the image. As stated above, according to the first example embodiment, the salesperson can efficiently perform the ordering operation.

In the first example embodiment, the operation of the person in charge, which is related to the display data emphasizing the location in which the ordering candidate product is located on the specified display shelf, which is displayed on the mobile apparatus 10, is detected, and the ordering information of the product is generated based on the operation, and the generated ordering information is transmitted. Accordingly, it is possible to seamlessly provide the ordering information to the apparatus (the server apparatus 20 or another apparatus) that performs the ordering process from the mobile apparatus 10, and it is possible to make the ordering operation more efficient.

[Modification Example of First Example Embodiment]

In the first example embodiment, the information of the ordering candidate product together with the route information is transmitted to the mobile apparatus 10(#1) from the server apparatus 20, and is displayed together with the route information on the mobile apparatus 10(#1), as illustrated in FIG. 13. However, since the display data emphasizing the location in which the ordering candidate product is located is output in (S156), the information of the ordering candidate product may not be displayed. In this case, it is not necessary to perform (S140) in FIG. 13. The server apparatus 20 transmits only the route information to the mobile apparatus 10(#1) in (S141), and the mobile apparatus 10(#1) displays only the route information in (S142).

In the first example embodiment, the route information is displayed in the mobile apparatus 10. However, the route to the specified display shelf may be determined by the person in charge. In this case, it is not necessary to perform (S136) to (S142) in FIG. 13, and the server apparatus 20 may not include the generation module 47. In (S134), the server apparatus 20 may transmit the information indicating the location of the display shelf within the store, as the information of the display shelf, to the mobile apparatus 10(#1). The person in charge can move to the specified display shelf based on the information.

In the first example embodiment, the mobile apparatus 10(#1) generates the ordering information, as illustrated in FIG. 14. However, the ordering operation may be performed using another apparatus. In this case, it is not necessary to perform (S157) and (S158) in FIG. 14, and the mobile apparatus 10 may not include the generation module 54.

The server apparatus 20 (confirmation module 45) may confirm the positional relationship between the mobile apparatus 10 and the specified display shelf based on the identification information of the nearest beacon apparatus 5 sent from the mobile apparatus 10. In this case, the mobile apparatus 10 sequentially transmits the identification information of the nearest beacon apparatus 5 to the server apparatus 20. The identification information may be transmitted at predetermined cycles, or may be transmitted when the nearest beacon apparatus 5 is changed. The server apparatus 20 (confirmation module 45) determines whether or not the person in charge exists in a location in which the person in charge can image the image of the specified display shelf based on the arrangement information of the beacon apparatuses 5 and the specified display shelf and the identification information of the nearest beacon apparatus 5 stored in the store layout table 33. The server apparatus 20 (confirmation module 45) outputs the display data that emphasizes the location in which the ordering candidate product is located on the specified display shelf to the mobile apparatus 10 after at least one process of the process of confirming that the entire specified display shelf or a part thereof is included in the image sent from the mobile apparatus 10 and the process of confirming the positional relationship between the mobile apparatus 10 and the specified display shelf is performed. As mentioned above, the process of confirming that the person in charge exists in front of the specified display shelf may be implemented by the method using the positional information items of the nearest beacon apparatus 5 and each display shelf in addition to the method using the image imaged in the mobile apparatus 10.

In a case where the only the latter confirmation method (confirmation method using the positional information) is used, it is not necessary to perform (S153) and (S154) in FIG. 14, and the product image information is not required in the product information table 34. In this case, the confirmation of the positional relationship between the mobile apparatus 10 and the specified display shelf and the determination of an output timing of the display data emphasizing the location in which the ordering candidate product is located on the specified display shelf may be performed by the mobile apparatus 10. The mobile apparatus 10 may retain the arrangement information of the display shelves and the beacon apparatuses 5 in advance, and may acquire the display data from the server apparatus 20 in advance. The mobile apparatus 10 confirms the positional relationship between the nearest beacon apparatus 5 and the specified display shelf by using the arrangement information, and may output the display data after the confirmation.

### Second Example Embodiment

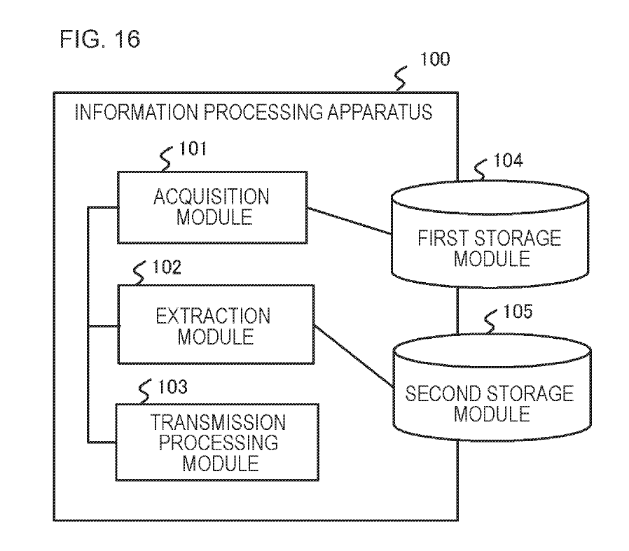

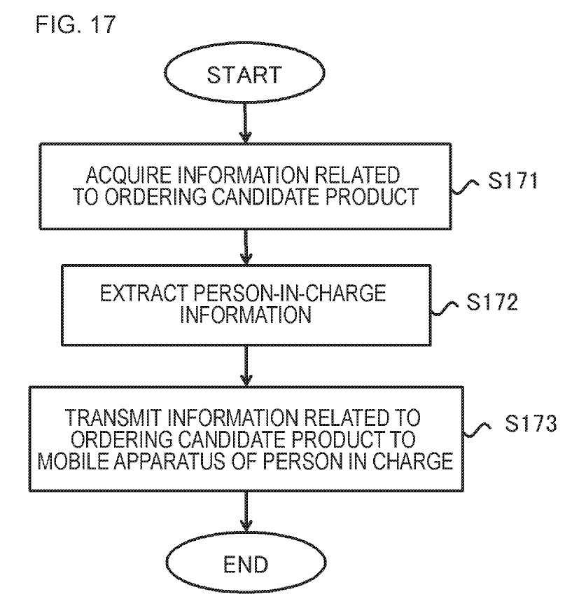

Hereinafter, an information processing apparatus and an ordering support method according to a second example embodiment will be described with reference to FIGS. 16 and 17. The second example embodiment may be a program causing at least one computer to perform the ordering support method, or may be a storage medium storing the program capable of being read by the at least one computer.

FIG. 16 is a conceptual diagram illustrating a processing configuration example of an information processing apparatus 100 according to the second example embodiment. The information processing apparatus 100 illustrated in FIG. 16 has the same hardware configuration as that of the server apparatus 20 illustrated in FIG. 2. The display apparatus 25 and the input apparatus 26 may not be connected to the information processing apparatus 100.

As illustrated in FIG. 16, the information processing apparatus 100 includes an acquisition module 101, an extraction module 102, and a transmission processing module 103. For example, a program stored in the memory 22 is executed by the CPU 21, and thus, the processing modules are implemented. For example, the program may be installed from a portable storage medium such as a CD or a memory card or another computer on a network through the communication unit 24, and may be stored in the memory 22. A first storage module 104 and a second storage module 105 may be provided on the memory 22 of the information processing apparatus 100, or may be implemented in another apparatus. In a case where another apparatus includes the first storage module 104 and the second storage module 105, the information processing apparatus 100 may access the first storage module 104 and the second storage module 105 through the communication using the communication unit 24.

The first storage module 104 stores ordering timing information of the product. A specific example of the first storage module 104 is the ordering time table 31 illustrated in FIG. 6. Although the ordering timing is stored in the ordering time table 31 for every shelf in the example of FIG. 6, the first storage module 104 may store the ordering timing for every product. The first storage module 104 may not store information of the ordering date in a case where the ordering date is fixed. In contrast, the first storage module 104 may not store information of the ordering time in a case where the ordering time is fixed. The first storage module 104 stores at least the product code for identifying each product and the ordering timing information of each product. The ordering timing information indicates any one or both of the ordering date and the ordering time.

The second storage module 105 stores the product or the person-in-charge information who manages the location in which the product is located. A specific example of the second storage module 105 is the person-in-charge table 32 illustrated in FIG. 7. The person-in-charge table 32 illustrated in FIG. 7 stores the identification information (shelf ID) of the display shelf for every person in charge. This is because the person in charge is assigned to each display shelf in the first example embodiment. The person in charge may be assigned to each product, or may be assigned to each shelf of the display shelf. Thus, the second storage module 105 may store the person-in-charge information and the product code, or may store the person-in-charge information and the identification information of the shelf. The identification information of the shelf is information for identifying the display shelf and the shelf of the display shelf.

The acquisition module 101 acquires the information related to the ordering candidate product based on the relationship between the current time and the ordering timing stored in the first storage module 104. The “ordering candidate product” means the product as the ordering candidate the ordering timing of which approaches. For example, the similarly to the acquisition module 41, the acquisition module 101 acquires the information related to the product (ordering candidate product) the ordering timing of which approaches within the predetermined time. The “information related to the ordering candidate product” includes any one or both of the information (product code or product name) of the ordering candidate product and the information of the location in which the ordering candidate product is located.

The extraction module 102 extracts the ordering candidate product or the person-in-charge information who manages the location in which the ordering candidate product is located from the second storage module 105. As described above, in a case where the person in charge is assigned to each product, the extraction module 102 extracts the person-in-charge information of the ordering candidate product. In a case where the person in charge is assigned to each shelf of the display shelf, the extraction module 102 extracts the person-in-charge information of the shelf on which the ordering candidate product is located. As in the first example embodiment, in a case where the person in charge is assigned to each display shelf, the extraction module 102 extracts the person-in-charge information of the display shelf in which the ordering candidate product is located. The extracted person-in-charge information is destination information (address or the like) for transmitting certain information to the mobile terminal of the person in charge indicated by the information or the information for determining the destination information.

The transmission processing module 103 transmits the information related to the ordering candidate product acquired by the acquisition module 101 to the mobile apparatus of the person in charge illustrated by the person-in-charge information extracted by the extraction module 102.

FIG. 17 is a flowchart illustrating an operation example of the information processing apparatus 100 according to the second example embodiment. As illustrated in FIG. 17, the ordering support method according to the second example embodiment is implemented by at least one computer such as the information processing apparatus 100. For example, the illustrated steps are performed by the processing modules of the information processing apparatus 100. The processing contents of the steps are the same as those of the processing modules, and thus, the details of the steps are not appropriately repeated.

The ordering support method according to the present example embodiment includes (S171), (S172), and (S173).

In (S171), the information processing apparatus 100 acquires the information related to the ordering candidate product based on the relationship between the current time and the ordering timing stored in the first storage module 104.

In (S172), the information processing apparatus 100 extracts the ordering candidate product or the person-in-charge information who manages the location in which the ordering candidate product is located from the second storage module 105.

In (S173), the information processing apparatus 100 transmits the information which is related to the ordering candidate product and is acquired in (S171) to the mobile apparatus of the person in charge indicated by the person-in-charge information extracted in (S172).

In the second example embodiment, the information related to the ordering candidate product of which the ordering timing approaches is transmitted to the mobile apparatus of the person in charge who manages the ordering candidate product or the person in charge who manages the location in which the ordering candidate product is located. As a result, if the information related to the ordering candidate product is displayed on the mobile apparatus, the person in charge can know the product of which the ordering timing approaches or the location among the products or the locations managed by the person in charge. Therefore, according to the second example embodiment, it is possible to prevent the missing of the order, and it is possible to support the ordering operation.

In the example embodiments and the modification example, the ordering operation is supported. However, the above-described contents are not applied to only the supporting of the ordering operation, and may support a customer service operation of the salesperson, and the behavior of the customer in the store. The second example embodiment supports the customer and the salesperson who search for the product in the store.

### Second Example Embodiment

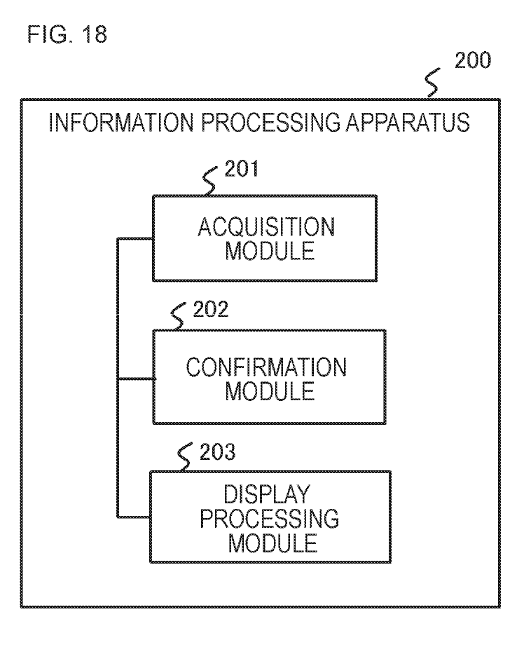

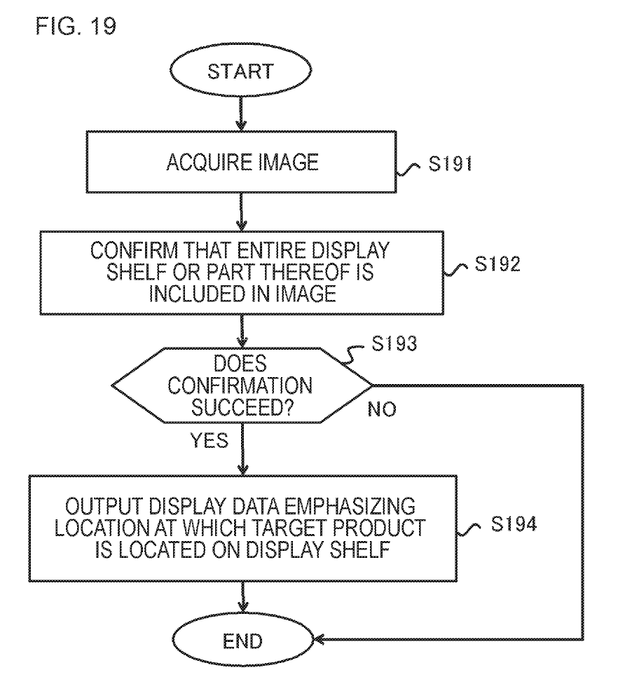

Hereinafter, an information processing apparatus and a support method according to a third example embodiment will be described with reference to FIGS. 18 and 19. The third example embodiment may be a program causing at least one computer to perform the support method, or may be a storage medium storing the program capable of being read by the at least one computer.

FIG. 18 is a conceptual diagram illustrating a processing configuration example of an information processing apparatus 200 according to the third example embodiment. The information processing apparatus 200 illustrated in FIG. 18 has the same hardware configuration as that of the server apparatus 20 illustrated in FIG. 2 or the mobile apparatus 10 illustrated in FIG. 3. That is, the information processing apparatus 200 may be a fixedly provided computer, or may be a mobile computer.

As illustrated in FIG. 18, the information processing apparatus 200 includes an acquisition module 201, a confirmation module 202, and a display processing module 203. For example, the CPU 11 or 21 executes a program stored in the memory 12 or 22, and thus, these processing modules are implemented. For example, the program may be installed from a portable storage medium such as a CD or a memory card or another computer on a network through the communication unit 15 or 24, and may be stored in the memory 12 or 22.

The acquisition module 201 acquires an image. The acquisition module 201 acquires the image imaged by the imaging unit 16. The acquisition module 201 acquires the image imaged by a mobile apparatus other than the information processing apparatus 200 from the other apparatus. The acquired image is an image imaged through the operation of the salesperson or the customer.

The confirmation module 202 confirms that the entire display shelf on which a target product is located or a part thereof is included in the image acquired by the acquisition module 201. For example, the “target product” is a product searched for by the salesperson or the customer. For example, the confirmation module 202 performs the confirmation by collating the product image included in the image acquired by the acquisition module 201 with the image of the product located on the same display shelf for the target product. A specific confirmation method performed by the confirmation module 202 is the same confirmation method performed by the confirmation module 45 except for the difference between the ordering candidate product and the target product.

After the confirmation performed by the confirmation module 202, the display processing module 203 outputs to a display module the display data emphasizing the location in which the target product is located on the display shelf on which the target product is located. A specific outputting method of the display is the same as the outputting method performed by the display processing module 46 except for the difference between the ordering candidate product and the target product. The display module as an output destination may be provided in the information processing apparatus 200, or may be provided in another mobile apparatus other than the information processing apparatus 200.

FIG. 19 is a flowchart illustrating an operation example of the information processing apparatus 200 according to the third example embodiment. As illustrated in FIG. 19, the support method according to the third example embodiment is performed by at least one computer such as the information processing apparatus 200. For example, the illustrated steps are performed by the processing modules of the information processing apparatus 200. The processing contents of the steps are the same as those of the processing modules, and thus, the details of the steps are appropriately not repeated.

The support method according to the present example embodiment includes (S191), (S192), and (S194).

In (S191), the information processing apparatus 200 acquires an image. The information processing apparatus 200 may acquire the image imaged by the imaging unit 16 of the information processing apparatus, or may acquire the image imaged by a mobile apparatus other than the information processing apparatus 200 from the mobile apparatus.

In (S192), the information processing apparatus 200 confirms that the entire display shelf on which the target product is located or apart thereof is included in the image acquired in (S191).

In a case where the information processing apparatus is able to confirm that the entire display shelf or a part thereof is included in the image in (S192) (S193; YES), the information processing apparatus 200 outputs the display data that emphasizes the location in which the target product is located on the display shelf on which the target product is located to the display module (S194). The display module may be provided in the information processing apparatus 200, or may be provided in another mobile apparatus other than the information processing apparatus 200.

In the third example embodiment, it is confirmed that the entire display shelf on which the target product is located or a part thereof is included in the acquired image, and the display data emphasizing the location in which the target product is located on the display shelf is output after the confirmation. Accordingly, the salesperson or the customer can immediately recognize whether or not the display shelf is the display shelf on which the target product is located by imaging the display shelf by using their mobile apparatus. In a case where the target product is located on the display shelf, the salesperson or the customer can view the display data that emphasizes the location in which the target product is located on the display shelf. Accordingly, even in a case where a plurality of products is located on the display shelf, the salesperson or the customer can immediately find the target product among the products. Therefore, according to the third example embodiment, it is possible to support the salesperson or the customer who searches for a desired product in the store.

### Fourth Example Embodiment

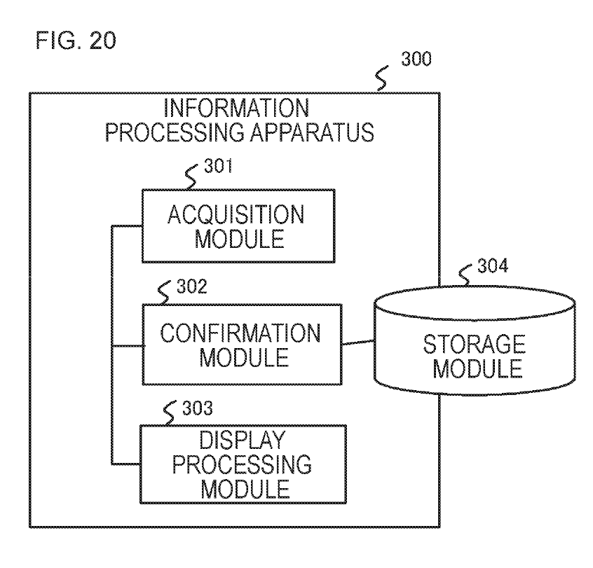

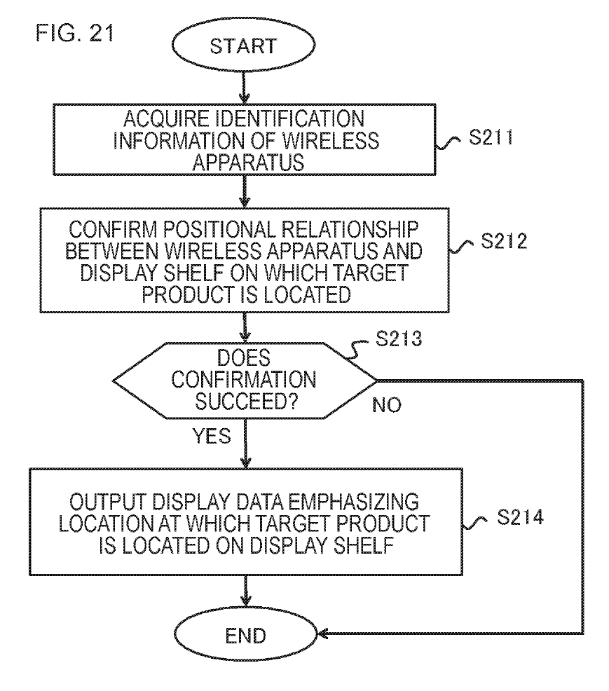

Hereinafter, an information processing apparatus and a support method according to a fourth example embodiment will be described with reference to FIGS. 20 and 21. The fourth example embodiment may be a program causing at least one computer to perform the support method, or may be a storage medium storing the program capable of being read by the at least one computer.

FIG. 20 is a conceptual diagram illustrating a processing configuration example of an information processing apparatus 300 according to the fourth example embodiment. The information processing apparatus 300 illustrated in FIG. 20 has the same hardware configuration as that of the server apparatus 20 illustrated in FIG. 2 or the mobile apparatus 10 illustrated in FIG. 3. That is, the information processing apparatus 200 may be a fixedly provided computer, or may be a mobile computer.

As illustrated in FIG. 20, the information processing apparatus 300 includes an acquisition module 301, a confirmation module 302, and a display processing module 303. For example, the CPU 11 or 21 executes a program stored in the memory 12 or 22, and thus, these processing modules are implemented. For example, the program may be installed from a portable storage medium such as a CD or a memory card or another computer on a network through the communication unit 15 or 24, and may be stored in the memory 12 or 22. A storage module 304 may be provided on the memory 12 or 22 of the information processing apparatus 300, or may be implemented in another apparatus. In a case where another apparatus includes the storage module 304, the information processing apparatus 300 may access the storage module 304 through the communication using the communication unit 15 or 24.

The acquisition module 301 is provided in a different location, and acquires identification information of one wireless apparatus of a plurality of wireless apparatuses that send radio signals including the identification information of the information processing apparatus. A specific example of the wireless apparatus is the beacon apparatus. Similarly to the beacon apparatuses, the wireless apparatuses are provided on the ceiling within the store. For example, the acquisition module 301 acquires identification information of the wireless apparatus nearest to the information processing apparatus 300 or nearest to the mobile apparatus other than the information processing apparatus 300. In a case where the identification information of the wireless apparatus nearest to the information processing apparatus 300 is acquired, the acquisition module 301 may determine the nearest wireless apparatus based on the radio wave intensity of the radio signal received from the wireless apparatus.

The storage module 304 stores arrangement information of the plurality of wireless apparatuses and a plurality of display shelves. A specific example of the storage module 304 is the store layout table 33 illustrated in FIG. 8. Although the positional information items of the display shelves and the beacon apparatuses 5 are stored in one table in the example of FIG. 8, the storage module 304 may store the positional information items of the wireless apparatuses and the display shelves in a plurality of tables.

The confirmation module 302 confirms the positional relationship between the wireless apparatus indicated by the identification information acquired by the acquisition module 201 and the display shelf on which the target product is located by referring to the storage module 304 based on the identification information of the wireless apparatus acquired by the acquisition module 201. For example, the confirmation module 302 confirms that the wireless apparatus is close to the display shelf on which the target product is located based on the arrangement information of the wireless apparatuses and the display shelves and the identification information of the wireless apparatus acquired by the acquisition module 301 which are stored in the storage module 304. Through the confirmation process, the confirmation module 302 confirms that there exists the salesperson or the customer who is the user of the information processing apparatus 300 or the salesperson or the customer who is the user the mobile apparatus other than the information processing apparatus 300, in front of the display shelf on which the target product is located.

After the confirmation performed by the confirmation module 302, the display processing module 303 outputs the display data emphasizing the location in which the target product is located on the display shelf on which the target product is located on a display module. The process of the display processing module 303 is the same as that of the display processing module 203. The display module may be provided in the information processing apparatus 300, or may be provided in the mobile apparatus other than the information processing apparatus 300.

FIG. 21 is a flowchart illustrating an operation example of the information processing apparatus 300 according to the fourth example embodiment. As illustrated in FIG. 21, the support method according to the fourth example embodiment is performed by at least one computer such as the information processing apparatus 300. For example, the illustrated steps are performed by the processing modules of the information processing apparatus 300. The processing contents of the steps are the same as those of the processing modules, and thus, the details of the steps are not appropriately repeated.

The support method according to the present example embodiment includes (S211), (S212), and (S214).

In (S211), the information processing apparatus 300 acquires the identification information of one wireless apparatus of the plurality of wireless apparatuses. For example, the information processing apparatus 300 acquires the identification information of the wireless apparatus nearest to the information processing apparatus 300 or nearest to the mobile apparatus other than the information processing apparatus 300.

In (S212), the information processing apparatus 300 confirms the positional relationship between the wireless apparatus illustrated by the identification information acquired in (S211) and the display shelf on which the target product is located by referring to the storage module 304 based on the identification information of the wireless apparatus acquired in (S211). For example, the proximity between the wireless apparatus and the display shelf is confirmed. Through (S212), the information processing apparatus 300 confirms that there exists the salesperson or the customer who is the user of the information processing apparatus 300 or the salesperson or the customer who is the user of the mobile apparatus other than the information processing apparatus 300, in front of the display shelf on which the target product is located.

In a case where the information processing apparatus is able to confirm that the salesperson or the customer exists in front of the display shelf (S212) (S213; YES), the information processing apparatus 300 outputs to a display module the display data that emphasizes the location in which the target product is located on the display shelf on which the target product is located (S214). The display module may be provided in the information processing apparatus 300, or may be provided in another mobile apparatus other than the information processing apparatus 300.

In the fourth example embodiment, the positional relationship between the wireless apparatus and the display shelf on which the target product is located is confirmed based on the acquired identification information of the wireless apparatus, and the display data emphasizing the location in which the target product is located is emphasized on the display shelf is output after the confirmation. Accordingly, the salesperson or the customer has the information processing apparatus 300 capable of receiving the radio signal output from the wireless apparatus or the mobile apparatus other than the information processing apparatus 300, and thus, the salesperson or the customer can immediately recognize whether or not the salesperson or the customer is close to the display shelf on which the target product is located. In a case where the salesperson or the customer is close to the display shelf, the salesperson or the customer can view the display data that emphasizes the location in which the target product is located on the display shelf. Accordingly, even in a case where a plurality of products is located on the display shelf, the salesperson or the customer can immediately find the target product among the products. Accordingly, according to the fourth example embodiment, it is possible to support the salesperson or the customer who searches for a desired product in the store.

Note that, although the plurality of steps (processes) are sequentially described in the plurality of flowcharts used in the aforementioned description, the order in which the steps performed in the example embodiments is not limited to the aforementioned order. In the example embodiments, the order of the illustrated steps may be changed with no hindrance on the contents. The example embodiments and the modification examples may be combined without conflicting between the contents.

Some or all of the example embodiments and modification examples may be determined as follows. However, the aforementioned contents are not limited to the following description.

1. An information processing apparatus including:

an acquisition module acquiring information related to an ordering candidate product based on a relationship between a current time and an ordering timing stored in a first storage module that stores ordering timing information of a product;

an extraction module extracting, from a second storage module, person-in-charge information of the ordering candidate product or a location in which the ordering candidate product is located, the second storage module storing the person-in-charge information of a product or a location in which the product is located; and

a transmission processing module transmitting the acquired information related to the ordering candidate product to a mobile apparatus of a person in charge who is indicated by the extracted person-in-charge information.

2. The information processing apparatus according to 1, further including:

a confirmation module confirming that an entire display shelf or a part of the display shelf on which the ordering candidate product is located is included in an image sent from the mobile apparatus; and

a display processing module outputting, to the mobile apparatus, display data that emphasizes the location in which the ordering candidate product is located on the display shelf on which the ordering candidate product is located, after the confirmation is performed.

3. The information processing apparatus according to 2, wherein the confirmation module performs the confirmation by collating a product image included in the image sent from the mobile apparatus with an image of a product located on the same display shelf as that of the ordering candidate product.

4. The information processing apparatus according to 2 or 3, further including a reception processing module receiving identification information of one wireless apparatus of a plurality of wireless apparatuses from the mobile apparatus, each of plurality of wireless apparatus being provided in different locations and respectively sending radio signals including identification information thereof,

wherein based on the received identification information of the wireless apparatus, the confirmation module confirms a positional relationship between the mobile apparatus and the display shelf on which the ordering candidate product is located, by referring to a third storage module that stores arrangement information of the plurality of wireless apparatuses and a plurality of display shelves, and

the display processing module outputs the display data to the mobile apparatus after at least one of: confirming that the entire display shelf or a part of the display shelf on which the ordering candidate product is located is included in the image; and confirming the positional relationship between the mobile apparatus and the display shelf on which the ordering candidate product is located.

5. The information processing apparatus according to any one of 1 to 4, further including:

a reception processing module receiving identification information of one wireless apparatus of a plurality of wireless apparatuses from the mobile apparatus, each of plurality of wireless apparatus being provided in different locations and respectively sending radio signals including identification information thereof; and

a generation module generating, based on the received identification information of the wireless apparatus, route information from the wireless apparatus indicated by the received identification information to the display shelf on which the ordering candidate product is located, by referring to a third storage module that stores arrangement information of the plurality of wireless apparatuses and a plurality of display shelves,

wherein the transmission processing module transmits the generated route information to the mobile apparatus.

6. The information processing apparatus according to 5,

wherein the transmission processing module transmits to the mobile apparatus identification information items of a plurality of display shelves on which a plurality of ordering candidate products is located,

the reception processing module receives from the mobile apparatus the identification information of the display shelf specified by the mobile apparatus, among the plurality of display shelves, and

the generation module generates route information from the wireless apparatus indicated by the received identification information to the display shelf indicated by the received identification information by referring to the third storage module

7. A mobile apparatus capable of communicating with the information processing apparatus according to any one of 1 to 6, the apparatus including: a display processing module outputting, to a display module, the display data that emphasizes the location in which the ordering candidate product is located on the display shelf on which the ordering candidate product is located.

8. The mobile apparatus according to 7, further including:

a detection module detecting an operation of the person in charge which is related to the display data output to the display module;

a generation module generating ordering information of the product based on the detected operation; and

a transmission processing module transmitting the generated ordering information.

9. An information processing apparatus including:

an acquisition module acquiring an image;

a confirmation module confirming that an entire display shelf or a part of the display shelf on which a target product is located is included in the acquired image; and

a display processing module outputting, to a display module, display data that emphasizes a location in which the target product is located on the display shelf on which the target product is located, after the confirmation is performed.

10. The information processing apparatus according to 9, wherein the confirmation module performs the confirmation by collating a product image included in the acquired image with an image of a product located on the same display shelf as that of the target product.

11. An information processing apparatus including:

an acquisition module acquiring identification information of one wireless apparatus of a plurality of wireless apparatuses, each of plurality of wireless apparatus being provided in different locations and respectively sending radio signals including identification information thereof;

a confirmation module confirming, based on the acquired identification information of the wireless apparatus, a positional relationship between the wireless apparatus indicated by the acquired identification information and a display shelf on which a target product is located, by referring to a storage module that stores arrangement information of the plurality of wireless apparatuses and a plurality of display shelves; and

a display processing module outputting, to a display module, display data that emphasizes a location in which the target product is located on the display shelf on which the target product is located, after the confirmation is performed.

12. An ordering support method performed by a computer capable of communicating with a mobile apparatus, the method including:

acquiring information related to an ordering candidate product based on a relationship between a current time and an ordering timing stored in a first storage module that stores ordering timing information of a product;

extracting, from a second storage module, person-in-charge information of the ordering candidate product or a location in which the ordering candidate product is located, the second storage module storing the person-in-charge information of a product or a location in which the product is located; and

transmitting the acquired information related to the ordering candidate product to a mobile apparatus of a person in charge who is indicated by the extracted person-in-charge information.

13. The ordering support method according to 12, further including:

confirming that an entire display shelf or a part of the display shelf on which the ordering candidate product is located is included in an image sent from the mobile apparatus; and

outputting, to the mobile apparatus, display data that emphasizes the location in which the ordering candidate product is located on the display shelf on which the ordering candidate product is located, after the confirmation is performed.

14. The ordering support method according to 13, wherein the confirmation includes collating a product image included in the image sent from the mobile apparatus with an image of a product located on the same display shelf as that of the ordering candidate product.

15. The ordering support method according to 13 or 14, further including:

receiving identification information of one wireless apparatus of a plurality of wireless apparatuses from the mobile apparatus, each of plurality of wireless apparatus being provided in different locations and respectively sending radio signals including identification information thereof; and

confirming a positional relationship between the mobile apparatus and the display shelf on which the ordering candidate product is located, by referring to a third storage module that stores arrangement information of the plurality of wireless apparatuses and a plurality of display shelves, based on the received identification information of the wireless apparatus,

wherein the display data is output to the mobile apparatus after at least one of: confirming that the entire display shelf or a part of the display shelf on which the ordering candidate product is located is included in the image; and confirming the positional relationship between the mobile apparatus and the display shelf on which the ordering candidate product is located.

16. The ordering support method according to any one of 12 to 15, further including:

receiving identification information of one wireless apparatus of a plurality of wireless apparatuses from the mobile apparatus, each of plurality of wireless apparatus being provided in different locations and respectively sending radio signals including identification information thereof;

generating, based on the received identification information of the wireless apparatus, route information from the wireless apparatus indicated by the received identification information to the display shelf on which the ordering candidate product is located, by referring to a third storage module that stores arrangement information of the plurality of wireless apparatuses and a plurality of display shelves; and

transmitting the generated route information to the mobile apparatus.

17. The ordering support method according to 16, further including transmitting to the mobile apparatus identification information items of a plurality of display shelves on which a plurality of ordering candidate products is located,

in the receiving of the identification information of the wireless apparatus, the identification information of the display shelf specified by the mobile apparatus, among the plurality of display shelves, is received from the mobile apparatus, and

in the generating of the route information, route information from the wireless apparatus indicated by the received identification information to the display shelf indicated by the received identification information is generated by referring to the third storage module.

18. A support method performed by a computer, the method including:

acquiring an image;

confirming that an entire display shelf or a part of the display shelf on which a target product is located is included in the acquired image; and

outputting, to a display module, display data that emphasizes a location in which the target product is located on the display shelf on which the target product is located, after the confirmation is performed.

19. The support method according to 18, in which the confirmation includes collating a product image included in the acquired image with an image of a product located on the same display shelf as that of the target product.

20. A support method performed by a computer, the method including:

acquiring identification information of one wireless apparatus of a plurality of wireless apparatuses, each of plurality of wireless apparatus being provided in different locations and respectively sending radio signals including identification information thereof;

a confirmation module confirming, based on the acquired identification information of the wireless apparatus, a positional relationship between the wireless apparatus indicated by the acquired identification information and a display shelf on which a target product is located, by referring to a storage module that stores arrangement information of the plurality of wireless apparatuses and a plurality of display shelves; and

a display processing module outputting, to a display module, display data that emphasizes a location in which the target product is located on the display shelf on which the target product is located, after the confirmation is performed.

21. A program causing at least one computer to perform the ordering support method according to 12 to 17 or the support method according to 18 to 20, or a storage medium storing the program capable of being read by the at least one computer.

This application is based on Japanese patent application NO. 2015-055253, filed Mar. 18, 2015, the content of which is incorporated hereinto by reference.

1. An information processing apparatus comprising a memory configured to store instructions and a processor configured to execute the instructions to:
acquire information related to an ordering candidate product based on a relationship between a current time and an ordering timing information of a product;
person-in-charge information of the ordering candidate product or a location in which the ordering candidate product is located; and
transmit the acquired information related to the ordering candidate product to a mobile apparatus of a person in charge who is indicated by the extracted person-in-charge information.

2. The information processing apparatus according to claim 1, wherein the processor is further configured to execute the instructions to:
confirm that an entire display shelf or a part of the display shelf on which the ordering candidate product is located is included in an image sent from the mobile apparatus; and
output, to the mobile apparatus, display data that emphasizes the location in which the ordering candidate product is located on the display shelf on which the ordering candidate product is located, after the confirmation is performed.

3. The information processing apparatus according to claim 2, wherein the processor is further configured to execute the instructions to perform the confirmation by collating a product image included in the image sent from the mobile apparatus with an image of a product located on the same display shelf as that of the ordering candidate product.

4. The information processing apparatus according to claim 2, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof,
based on the received identification information of the wireless apparatus, confirm a positional relationship between the mobile apparatus and the display shelf on which the ordering candidate product is located, and
output the display data to the mobile apparatus after at least one of: confirming that the entire display shelf or a part of the display shelf on which the ordering candidate product is located is included in the image; and confirming the positional relationship between the mobile apparatus and the display shelf on which the ordering candidate product is located.

5. The information processing apparatus according to claim 1, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

6. The information processing apparatus according to claim 5, wherein the processor is further configured to execute the instructions to:
transmit to the mobile apparatus identification information items of a plurality of display shelves on which a plurality of ordering candidate products is located,
receive from the mobile apparatus the identification information of the display shelf specified by the mobile apparatus, among the plurality of display shelves, and
generate route information from the wireless apparatus indicated by the received identification information to the display shelf indicated by the received identification information.

7. A mobile apparatus capable of communicating with the information processing apparatus according to claim 1, wherein the mobile apparatus comprising: a memory configured to store instructions; and a processor configured to execute the instructions to output, to a display module, the display data that emphasizes the location in which the ordering candidate product is located on the display shelf on which the ordering candidate product is located.

8. The mobile apparatus according to claim 7, wherein the processor of the mobile apparatus is further configured to execute the instructions to:
detect an operation of the person in charge which is related to the display data output to the display module;
generate ordering information of the product based on the detected operation; and
transmit the generated ordering information.

9-11. (canceled)

12. An ordering support method performed by a computer capable of communicating with a mobile apparatus, the method comprising:
acquiring information related to an ordering candidate product based on a relationship between a current time and an ordering timing information of a product;
extracting person-in-charge information of the ordering candidate product or a location in which the ordering candidate product is located; and
transmitting the acquired information related to the ordering candidate product to a mobile apparatus of a person in charge who is indicated by the extracted person-in-charge information.

13-14. (canceled)

15. A non-transitory computer-readable storage medium storing a program causing a processor of at least one computer to execute:
acquiring information related to an ordering candidate product based on a relationship between a current time and an ordering timing information of a product;
extracting person-in-charge information of the ordering candidate product or a location in which the ordering candidate product is located; and
transmitting the acquired information related to the ordering candidate product to a mobile apparatus of a person in charge who is indicated by the extracted person-in-charge information.

16. A mobile apparatus comprising a memory configured to store instructions and a processor configured to execute the instructions to:
output, to a display module, display data that emphasizes a location in which a candidate product of ordering is located on the display shelf,
detect an operation related to the display data output to the display module; and
generate ordering information of the product based on the detected operation.

17. The information processing apparatus according to claim 3, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof,
based on the received identification information of the wireless apparatus, confirm a positional relationship between the mobile apparatus and the display shelf on which the ordering candidate product is located, and
output the display data to the mobile apparatus after at least one of: confirming that the entire display shelf or a part of the display shelf on which the ordering candidate product is located is included in the image; and confirming the positional relationship between the mobile apparatus and the display shelf on which the ordering candidate product is located.

18. The information processing apparatus according to claim 2, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

19. The information processing apparatus according to claim 3, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

20. The information processing apparatus according to claim 4, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

21. The information processing apparatus according to claim 3, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

22. The information processing apparatus according to claim 17, wherein the processor is further configured to execute the instructions to:
receive identification information of one wireless apparatus of a plurality of wireless apparatuses from the mobile apparatus, each of plurality of wireless apparatus being provided in different locations and respectively sending radio signals including identification information thereof; and
generate, based on the received identification information of the wireless apparatus, route information from the wireless apparatus indicated by the received identification information to the display shelf on which the ordering candidate product is located,
transmit the generated route information to the mobile apparatus.

23. The information processing apparatus according to claim 18, wherein the processor is further configured to execute the instructions to:
transmit to the mobile apparatus identification information items of a plurality of display shelves on which a plurality of ordering candidate products is located,
receive from the mobile apparatus the identification information of the display shelf specified by the mobile apparatus, among the plurality of display shelves, and
generate route information from the wireless apparatus indicated by the received identification information to the display shelf indicated by the received identification information.

24. The information processing apparatus according to claim 19, wherein the processor is further configured to execute the instructions to:
transmit to the mobile apparatus identification information items of a plurality of display shelves on which a plurality of ordering candidate products is located,
receive from the mobile apparatus the identification information of the display shelf specified by the mobile apparatus, among the plurality of display shelves, and
generate route information from the wireless apparatus indicated by the received identification information to the display shelf indicated by the received identification information.

25. The information processing apparatus according to claim 20, wherein the processor is further configured to execute the instructions to:
transmit to the mobile apparatus identification information items of a plurality of display shelves on which a plurality of ordering candidate products is located,
receive from the mobile apparatus the identification information of the display shelf specified by the mobile apparatus, among the plurality of display shelves, and
generate route information from the wireless apparatus indicated by the received identification information to the display shelf indicated by the received identification information.
